(19) United States
(12) Patent Application Publication
(10) Pub. No.: US 2018/0171190 A1
(43) Pub. Date: Jun. 21, 2018

(54) FORMULATIONS AND APPLICATIONS OF WET-ADHESIVES

(71) Applicant: ACatechol, Inc., Santa Barbara, CA (US)

(72) Inventor: Byung Jun Ahn, Goleta, CA (US)

(73) Assignee: ACatechol, Inc., Santa Barbara, CA (US)

(21) Appl. No.: 15/845,738

(22) Filed: Dec. 18, 2017

Related U.S. Application Data
(60) Provisional application No. 62/436,285, filed on Dec. 19, 2016.

(51) Int. Cl. C09J 139/04; C09J 9/00; C09J 5/00; C09J 133/06; B05D 5/10; B05D 3/04

(52) U.S. Cl. CPC C09J 139/04; C09J 9/00; C09J 5/00; C09J 2433/00; B05D 5/10; B05D 3/0406; C09J 2201/614; C09J 133/066

(57) ABSTRACT

The present application discloses methods for using an adhesive composition comprising a polymer of the formulae A, B and C:

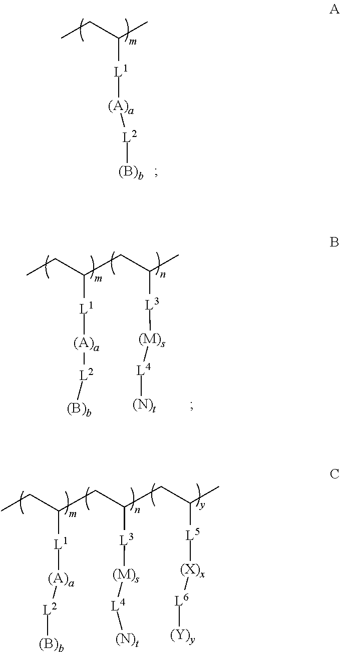

wherein the variables are as defined herein.

### RELATED APPLICATIONS

The present application claims priority to U.S. Provisional Application No. 62/436,285 filed Dec. 19, 2016, the content of which is incorporated herein by reference.

### BACKGROUND

Phase transitions of aqueous solutions of charged polymers and proteins have been reported. See Wei, W.; Waite, J. H. et al., A mussel-derived one component adhesive coacervate. Acta Biomater 2014, 10 (4), 1663-1670; Ahn, B. K.; Das; Lipshutz, B. H.; Israelachvili, J. N.; Waite, J. H. et al., High-performance mussel-inspired adhesives of reduced complexity. Nat Commun, 2015, 6; J. N.; Waite, J. H.; Ahn, B. K. et al., Microphase Behavior and Enhanced Wet-Cohesion of Synthetic Copolyampholytes Inspired by a Mussel Foot Protein. J Am Chem Soc, 2015, 137 (29), 9214-9217; Brangwynne, C. P. et al., Polymer physics of intracellular phase transitions. Nat Phys, 2015, 11 (11), 899-904. Cation-π interaction is strong in aqueous media and may be used for wet-adhesion in biology. See Lu, Q., et al., Adhesion of mussel foot proteins to different substrate surfaces. Journal of the Royal Society Interface, 2013, 10 (79). To the applicant's knowledge, successfull commercial applications for consumer products using such polymer compositions have been limited.

### SUMMARY OF THE INVENTION

Many different type of surface materials or surfaces become slippery when they get wet via moisture deposit or sweat, such as when a person is engaged in sport activities such as playing tennis, pingpong, basketball, football, doing rock climbing or in contact with salt water, such as surfing, using a face mask while scuba diving, among other activities. SweaTack™ coatings may be applied on a surface, such as by spraying or rubbing on the surface, such as a floor, or person's skin. Within a short period time, depending on the formulation and the atmospheric condition, such as a few seconds after the application of the formulation to the surface, the formulation further activates when placed in contact with ionic molecules, moisture or water, such as salty water, and the surface becomes tacky and allows better control, grip or traction to the surface.

In one aspect of the present application, there is disclosed compositions, methods for improving tackiness (initial adhesion), traction, grip or control of a surface, the method comprises: 1) administering to the surface a composition comprising an adhesive composition and a solvent, wherein the adhesive composition comprises a polymer selected from the group consisting of the formulae A, B and C, or a mixture thereof:

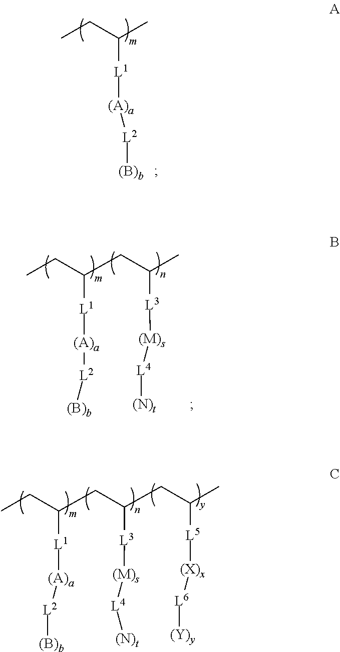

wherein:

each m, n and o is independently 100 to 1,000,000,000;

each a, b, s, t, x and y is independently 0, 1 or 2;

each L¹, L², L³, L⁴, L⁵ and L⁶ is independently absent or is independently selected from the group consisting of —CH₂—, —O—, —S—, —(CH₂)₁₋₂—, —CH(CH₂-)₂-, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl, or a bond;

each A, B, M, N, X and Y is independently absent or selected from the group consisting of an aryl, substituted aryl, aryl ammonium, heteroaryl, substituted heteroaryl, heteroarylammonium X⁻ and substituted heteroarylammonium X⁻, wherein each X⁻ is independently a counter anion selected from the group consisting of Cl⁻, Br⁻, I⁻, —SO₄⁻², —O—SO₃H⁻, —PO₄⁻³, —O—PO₃H₂⁻; provided that not all of L¹, L², L³, L⁴, L⁵ and L⁶, and A, B, M, N, X and Y are absent; and

2) allowing the solvent to evaporate for a sufficient period of time to allow the composition to set on the surface.

In one aspect of the composition, the mono-hydroxybenzyl are substituted as 2-hydroxy-, 3-hydroxy- or 4-hydroxybenzyl; the di-hydroxybenzyl are substituted as 2,3-dihydroxy, 2,4-dihydroxy or 3,5-dihydroxy; the tri-hydroxybenzyl are substituted as 2,3,4-trihydroxy and 3,4,5-tri-hydroxybenzyl. In one aspect of the method, the adhesive composition is further activated when placed in contact with an ionic solution or moisture selected from the group consisting of a salty solution (e.g., sea water or a saline solution) or bodily fluids selected from the group consisting of sweat, tears and blood, or mixtures thereof.

As used herein, the adhesive composition may also be considered to be a non-adhesive composition, priming or coating composition, since the composition adheres or binds (as an adhesive) to the first surface when initially applied to the first surface, after allowing the solvent to evaporate and the composition to set or adhere on the first surface. But the composition does not substantially adhere to or bind (acting as a non-adhesive when it is substantially or completely dry) to the second surface. Such adhesive material (or non-adhesive material) may be considered as pressure sensitive adhesives when there is moisture, such as a salty mist. The adhesive are effective for an extended period of time, and does not require frequent re-application. The term “adhesive” as used herein refers to a sticky, adherent, tacky, substance that causes a material, such as a surface, to adhere to, and/or makes a surface tacky and sticky, and may be generally referred to as a pressure-sensitive adhesive.

In one aspect of the above method, each A, B, M, N, X and Y is independently selected from the group consisting of:

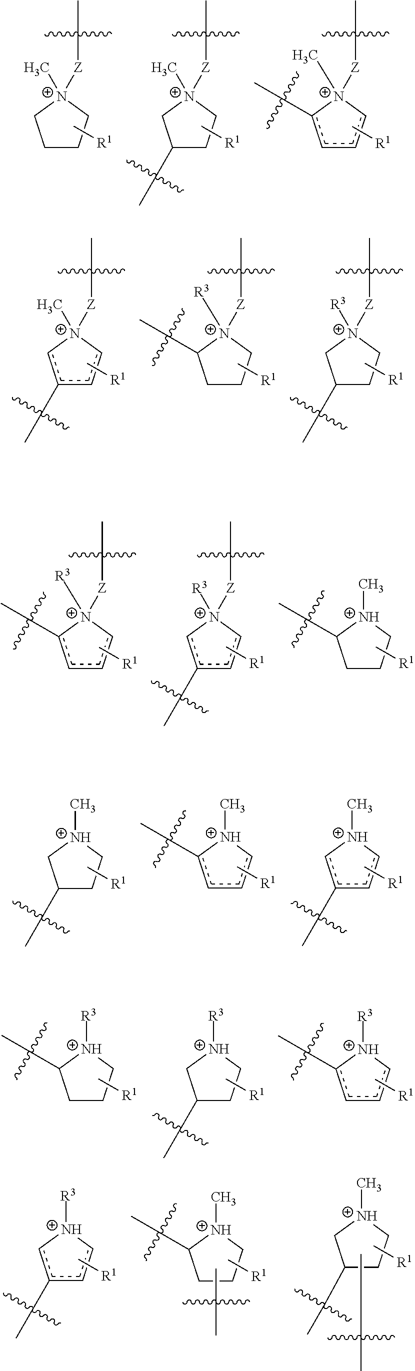

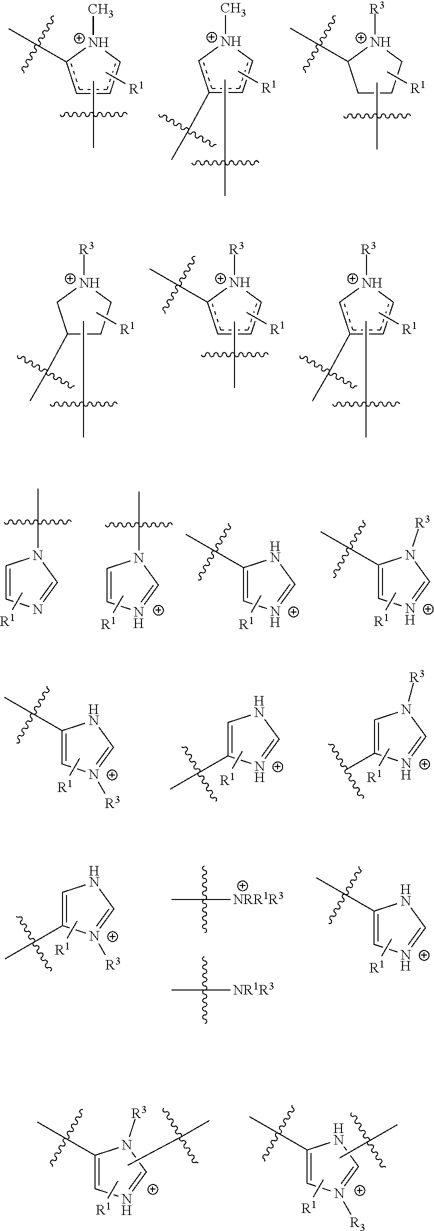

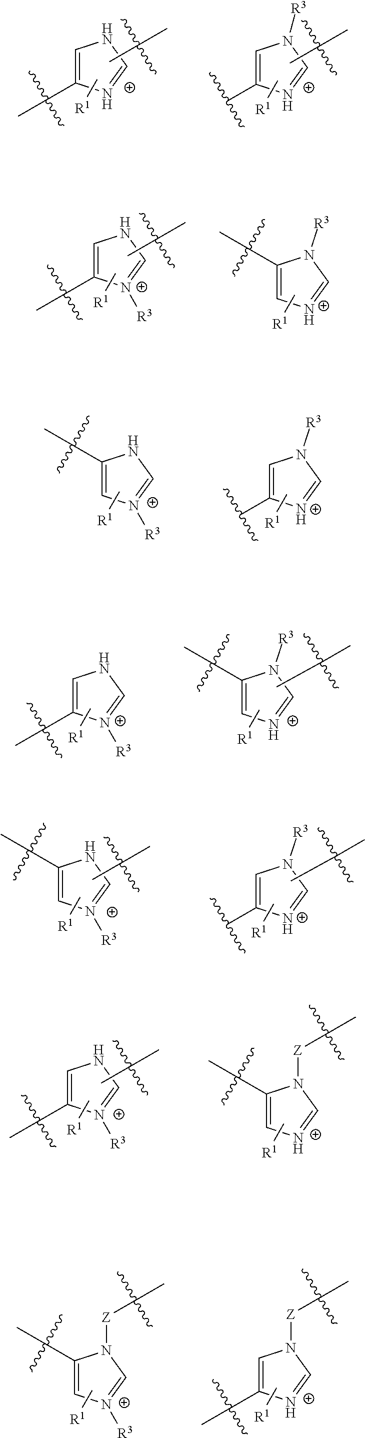

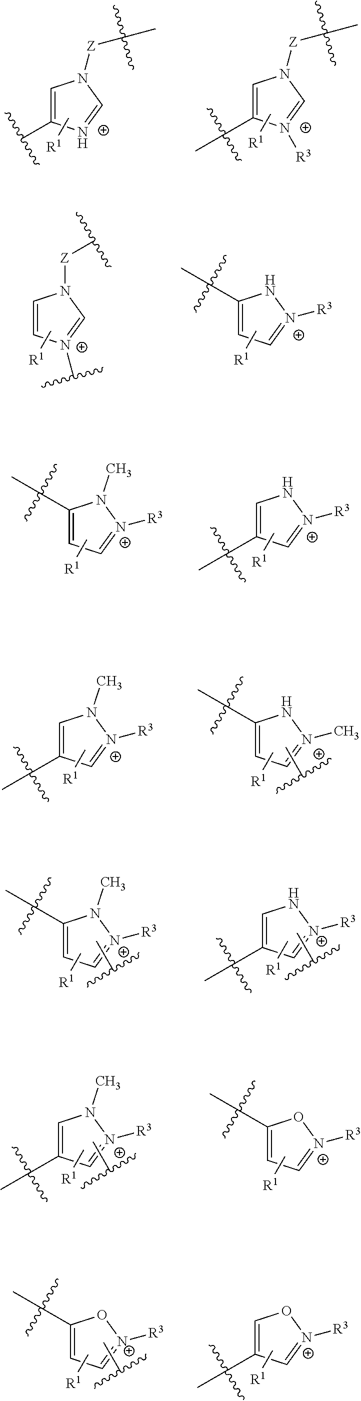

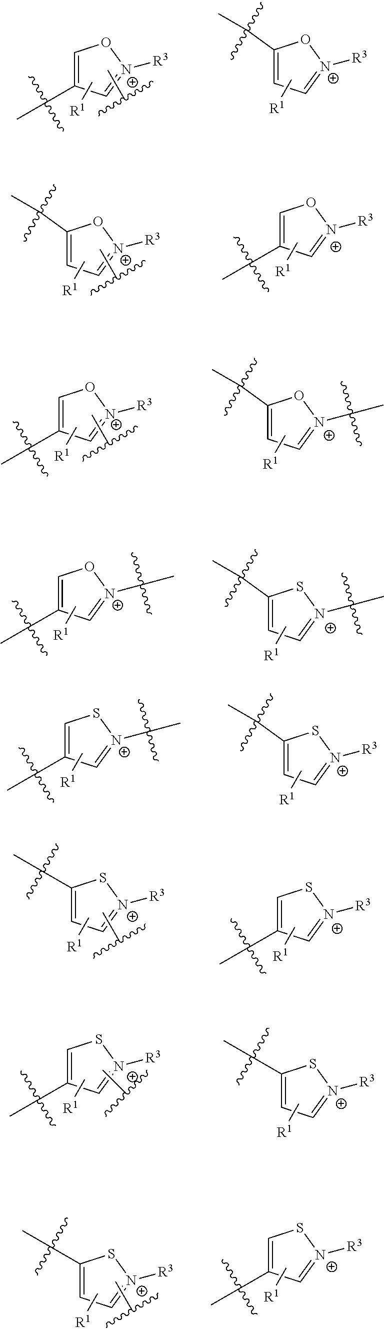

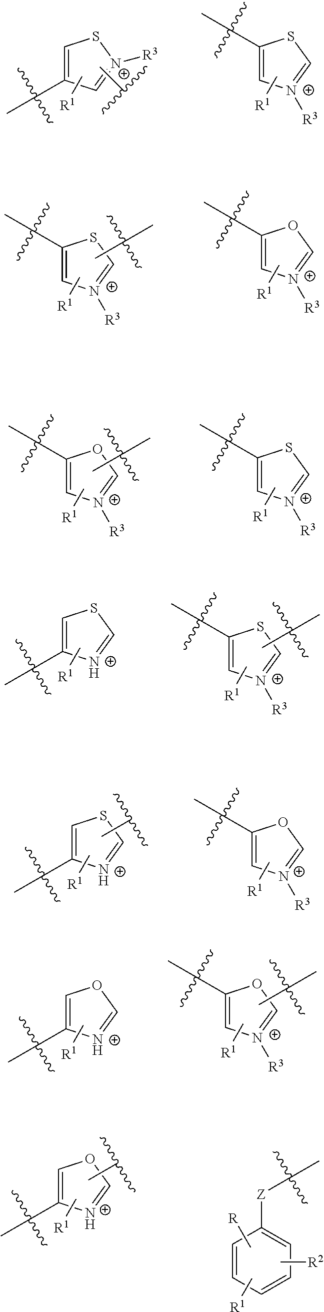

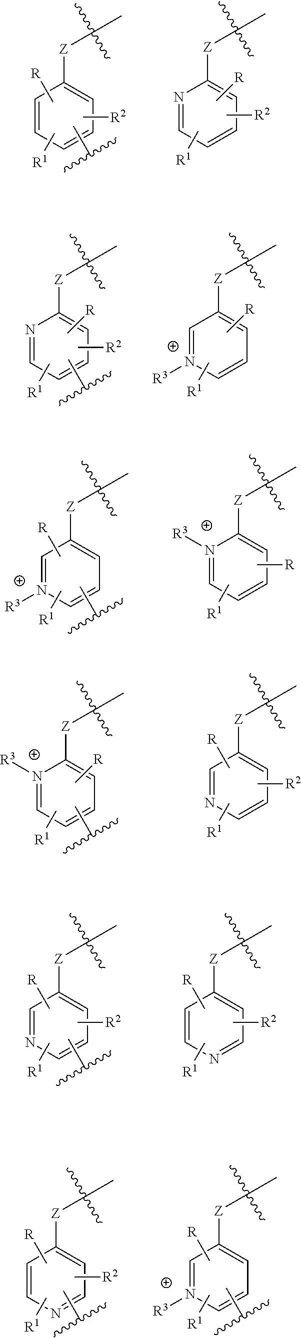

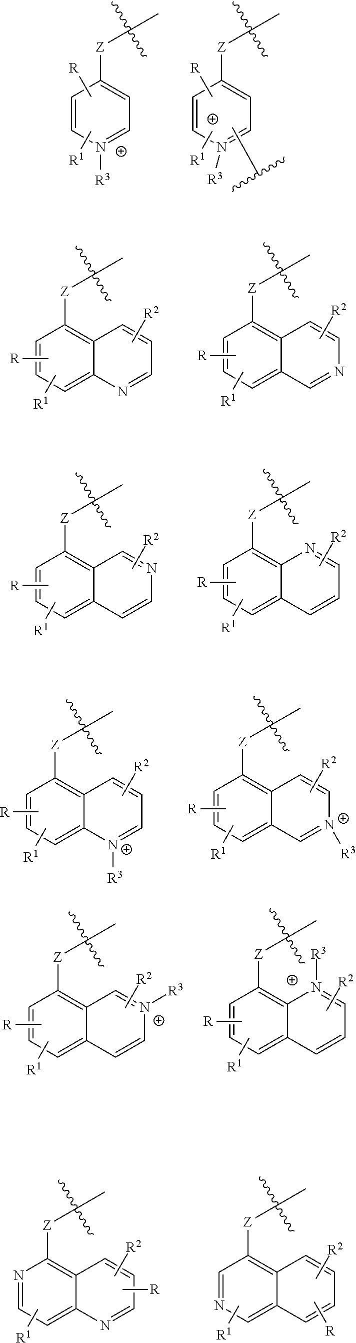

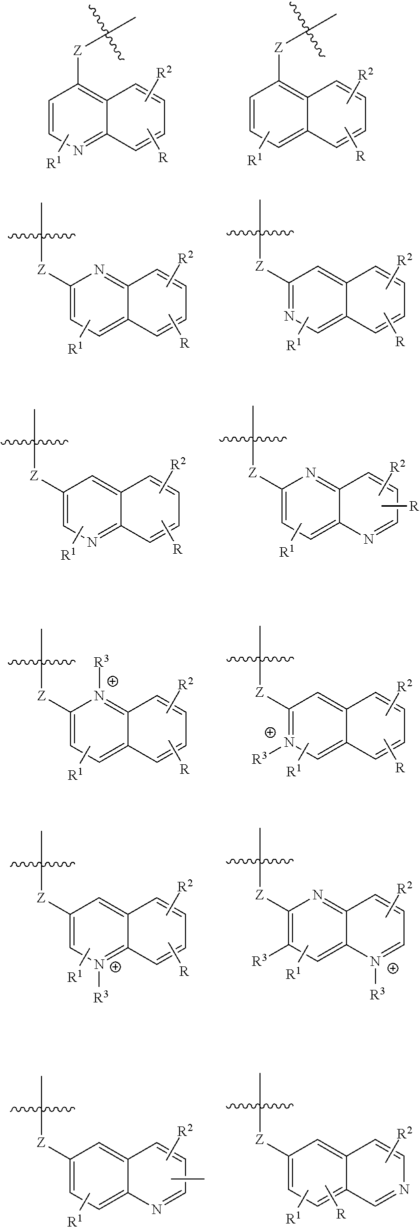

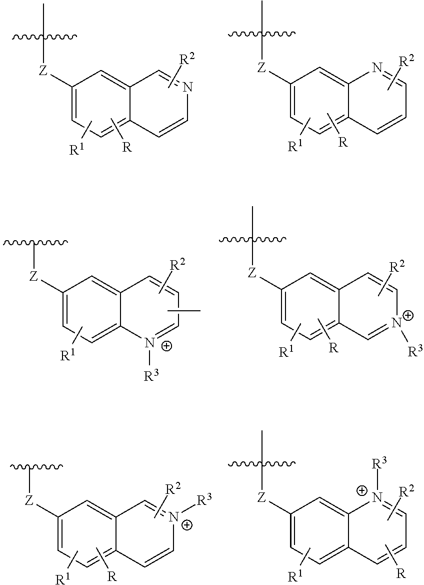

each L¹, L², L³ and L⁴ is independently H, —CH₃, —CH₂—, —O—, —S—, —(CH₂)₁₋₂—, —CH(CH₂-)₂, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅, a bond and —NR′— where R′ is selected from H, —CH₃, —CH₂CH₃ and —CH₂C₆H₅ or substituted benzyl or mono-, di-, tri-hydroxyl benzyl;

each R, R¹ and R² is independently H or is selected from the group consisting of F, Cl, Br, I, —OH, —SiH₂OH, —NO₂, —CH₃, a substituted aryl group, —CO₂H, —SO₃H, —O—SO₃H⁻, —PO₄⁻³, —O—PO₃H₂, —NH₃⁺, —CH₂C₆H₅, -3,4-dihydroxyphenyl, —CH₂-3,4-dihydroxyphenyl, N-succinimidyl, —NR′R″ where R′ and R″ are each independently selected from H, —CH₃, —CH₂CH₃ and —CH₂C₆H₅ or substituted benzyl or mono-, di-, tri-hydroxyl benzyl;

each R³ is independently H or is selected from the group consisting of —CH₃, —CH₂CH₃, a substituted aryl group, —CO₂H, —SO₃H, —O—SO₃H⁻, —PO₄, —O—PO₃H₂⁻, —NH₃⁺ and —CH₂C₆H₅ or substituted benzyl or mono-, di-, tri-hydroxyl benzyl; and Z is —(CH₂)ₜ— or —(NH)— where t is 0 or 1.

In another aspect of the method, the adhesive comprises of the formulae A¹¹ or A¹²

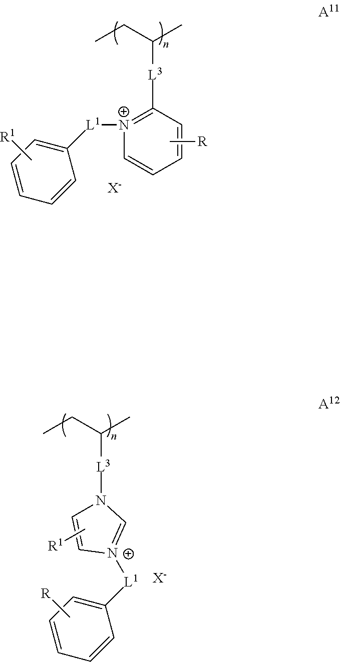

wherein: each n is independently 100 to 10,000,000;

each L¹ and L³ is independently selected from a bond, —CH₂—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;

each R and R¹ is independently H or is selected from the group consisting of F, Cl, Br, I, —OH, —SiH₂OH, —NO₂, —CH₃, —CO₂H, —SO₃H, —O—SO₃H⁻, —PO₄⁻³, —O—PO₃H₂, —NH₃⁺ and —NR′R″ where R′ and R″ are each independently selected from H, —CH₃, —CF₃, —CH₂CH₃ and —CH₂C₆H₅ or substituted benzyl or mono-, di-, tri-hydroxyl benzyl; and each X⁻ is independently a counter anion selected from the group consisting of Cl⁻, Br⁻ and I⁻. In one variation of the formula A¹¹, R¹ is 4-CH₃ or 4-CF₃. In another variation of the formula A¹², R¹ is 4-CH₃ or 4-CF₃.

In another aspect of the method, the adhesive comprises of the formulae B¹, B², B³, B⁴ and B⁵:

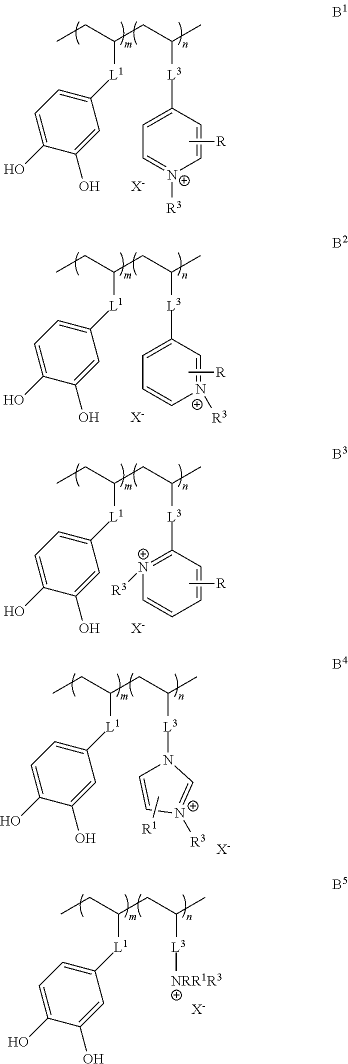

wherein: each m and n is independently 100 to 10,000,000;

each L¹ and L³ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;

each R and R¹ is independently H or is selected from the group consisting of F, Cl, Br, I, —OH, —SiH₂OH, —NO₂, —CH₃, —CO₂H, —SO₃H, —O—SO₃H⁻, —PO₄⁻³, —O—PO₃H₂, —NH₃⁻, —CH₂C₆H₅, -3,4-dihydroxyphenyl, —CH₂-3,4-dihydroxyphenyl, —NR′R″ where R′ and R″ are each independently selected from H, —CH₃, —CH₂CH₃, —CH₂C₆H₅ or substituted benzyl or mono-, di-, tri-hydroxyl benzyl;

each R³ is independently H or is selected from the group consisting of —CH₃, —CH₂CH₃, —CO₂H, —SO₃H, —O—SO₃H, —PO₄⁻, —O—PO₃H₂⁻, —NH₃⁺, —CH₂C₆H₅ or substituted benzyl or mono-, di-, tri-hydroxyl benzyl; and

each X⁻ is independently a counter anion selected from the group consisting of Cl⁻, Br⁻, I⁻, —SO₄⁻² and —PO₄⁻³.

In another aspect of the method, the adhesive comprises of the formulae C¹, C², C³, C⁴, C⁵ and C⁶:

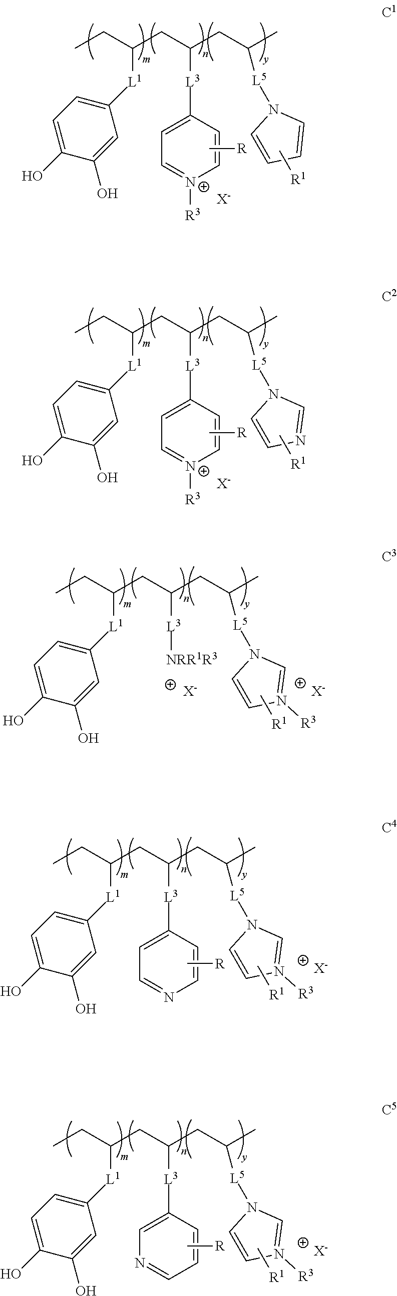

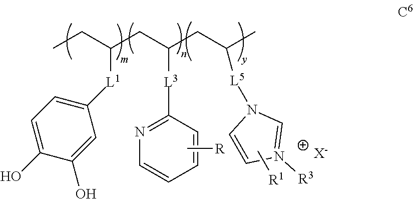

wherein: each m, n and y is independently 100 to 1,000,000,000 (the copolymer can be random or ordered or blocked);

each L¹, L³ and L⁵ is independently selected from —CH₂—, —O—, —S—, —(CH₂)₁₋₂—, —CH(CH₂-)₂, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl, or a bond;

each R and R¹ is independently H or is selected from the group consisting of F, Cl, Br, I, —OH, —SiH₂OH, —NO₂, —CH₃, —CO₂H, —SO₃H, —O—SO₃H⁻, —PO₄⁻³, —O—PO₃H₂, —NH₃⁺, —CH₂C₆H₅ or substituted benzyl or mono-, di-, tri-hydroxyl benzyl, -3,4-dihydroxyphenyl, —CH₂-3,4-dihydroxyphenyl and —NR′R″ where R′ and R″ are each independently selected from H, —CH₃, —CH₂CH₃ and —CH₂C₆H₅ or substituted benzyl or mono-, di-, tri-hydroxyl benzyl;

each R³ is independently H or is selected from the group consisting of —CH₃, —CH₂CH₃, —CO₂H, —SO₃H, —O—SO₃H⁻, —PO₄⁻³, —O—PO₃H₂⁻, —NH₃⁺ and —CH₂C₆H₅; and each X⁻ is independently a counter anion selected from the group consisting of Cl⁻, Br⁻, I⁻, —O—SO₃H⁻, —PO₄⁻³, —O—PO₃H₂, acetate, benzoate and lauryl-sulfate.

In another aspect of the method, the adhesive comprise of the formulae wherein B, N and Y are each independently a substituted aryl group.

In yet another aspect of the method, the substituted aryl group is selected from the group consisting of:

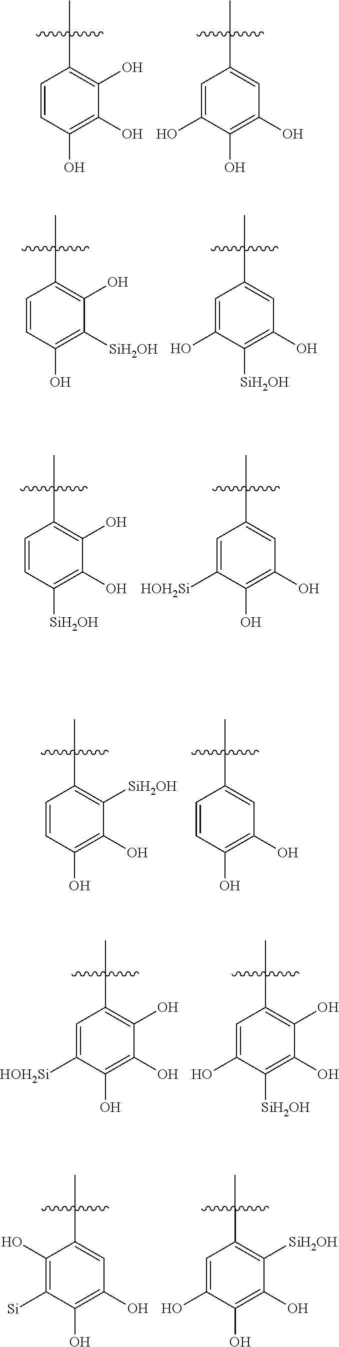

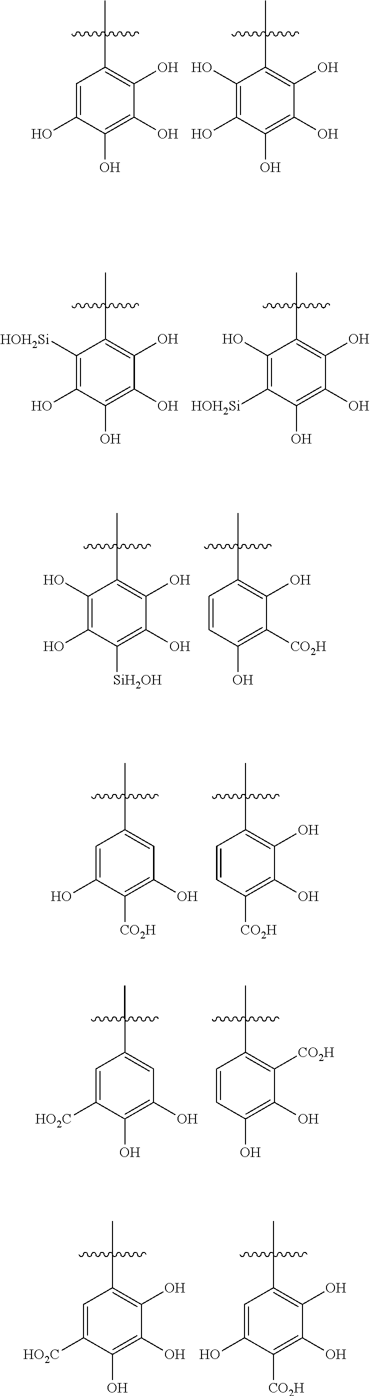

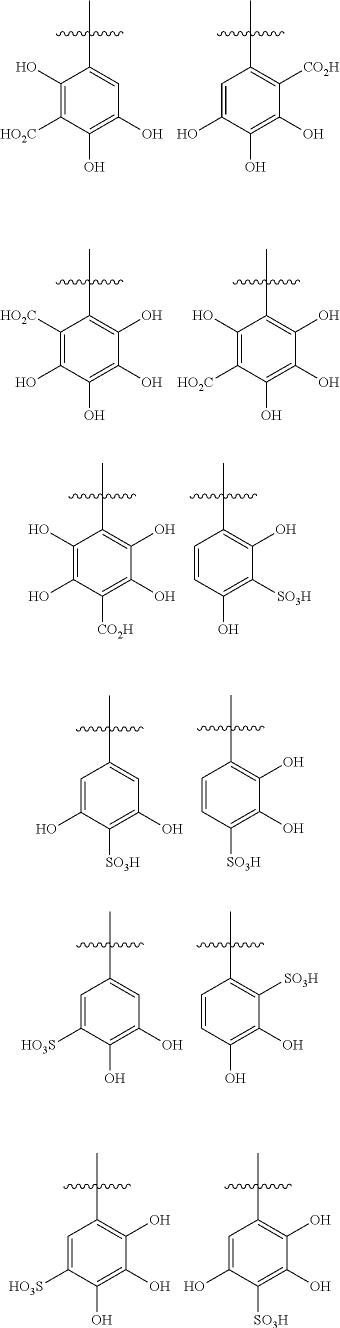

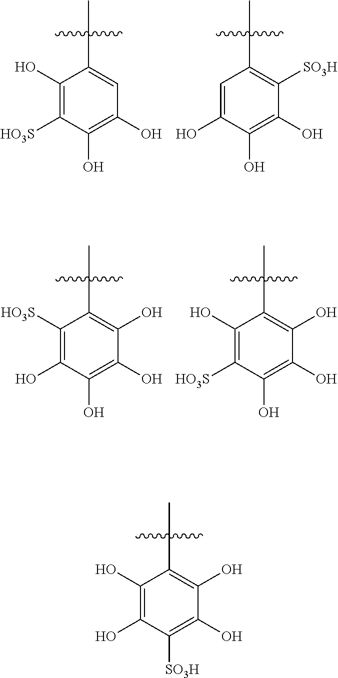

and b, n and y is 1 or 2.

In yet another aspect of the method, the adhesive comprises of the formulae A¹, A², A³, A⁴, A⁵, A⁶, A⁷, A⁸, A⁹, A¹⁰, A¹¹, A¹², A¹³ and A¹⁴;

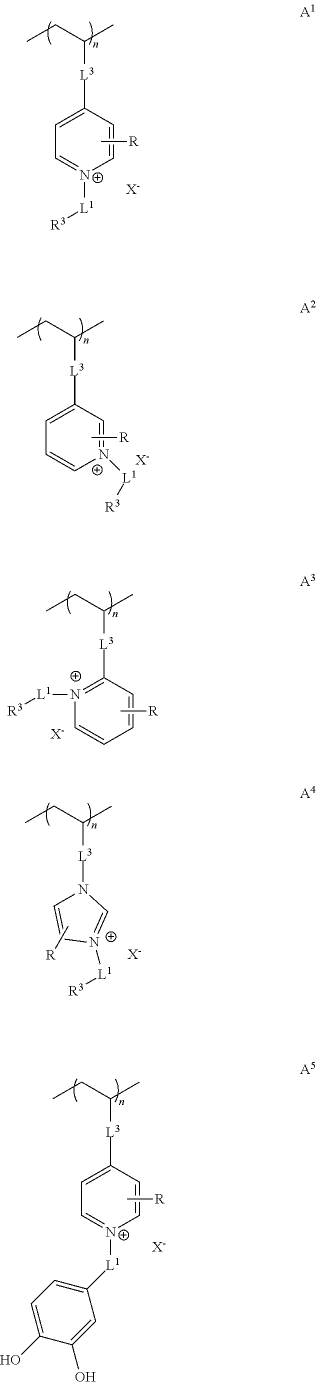

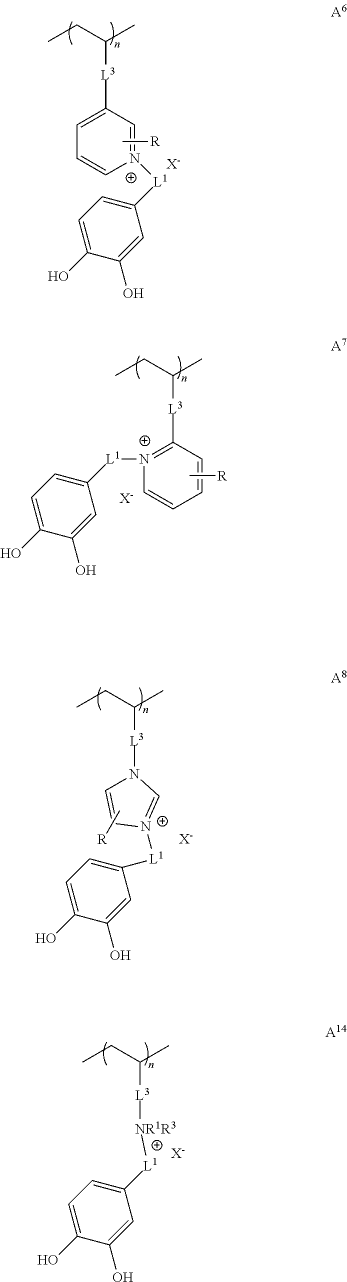

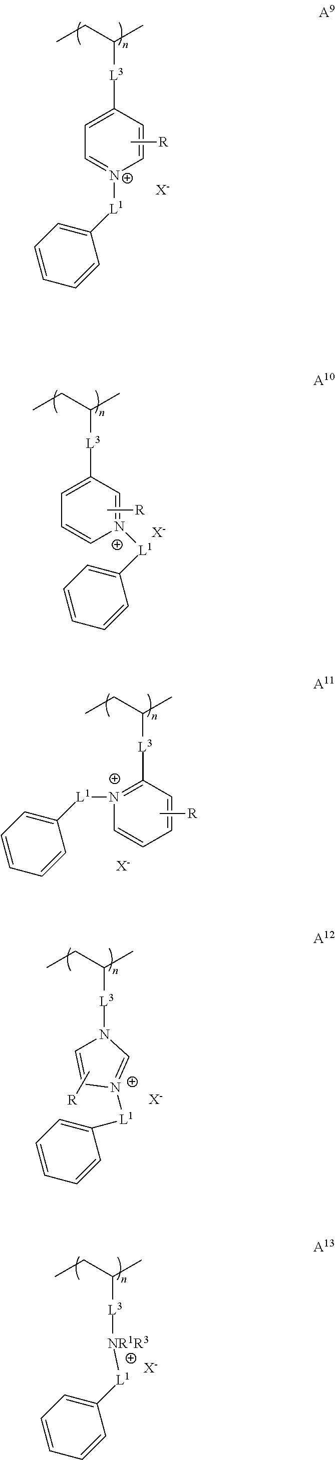

wherein: each n is independently 100 to 10,000,000;

each L¹ and L³ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;

each R and R¹ is independently H or is selected from the group consisting of F, Cl, Br, I, —OH, —SiH₂OH, —NO₂, —CH₃, —CO₂H, —SO₃H, —O—SO₃H⁻, —PO₄⁻³, —O—PO₃H₂, —NH₃⁺, —CH₂C₆H₅, -3,4-dihydroxyphenyl, —CH₂-3,4-dihydroxyphenyl, —NR′R″ where R′ and R″ are each independently selected from H, —CH₃, —CH₂CH₃ and —CH₂C₆H₅ or substituted benzyl or mono-, di-, tri-hydroxyl benzyl;

each R³ is independently H or is selected from the group consisting of —CH₃, —CH₂CH₃ and —CH₂C₆H₅ where the C₆H₅ group is optionally substituted with 1 substituent selected from the group consisting of halogen (—F, —Cl, —Br— or —I), —OH, —SH, —SiH₂OH, —NH₂, —NO₂, —CO₂H, —SO₃H, —O—SO₃H⁻, —PO₄⁻³, —O—PO₃H₂⁻ and —PO₃H₂⁻, —NH₃⁺, —CH₃, —CF₃, —OCH₃ and —OCF₃; and each X⁻ is independently a counter anion selected from the group consisting of Cl⁻, Br⁻, I⁻, —SO₄⁻² and —PO₄⁻³, acetate, benzoate and lauryl-sulfate.

In yet another aspect of the method, the adhesive comprises of the formulae B¹, B², B³, B⁴, B⁵ and B⁶:

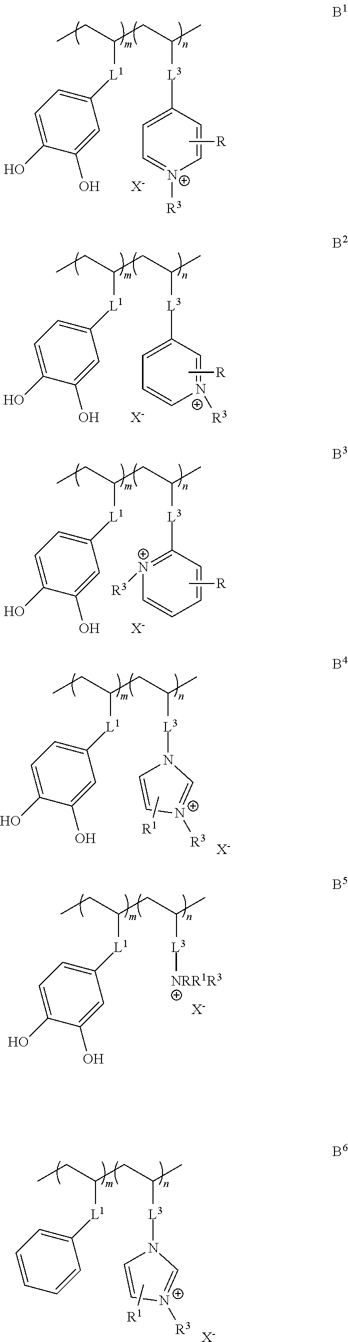

wherein: each m and n is independently 100 to 10,000,000;

each L¹ and L³ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;

each R and R¹ is independently H or is selected from the group consisting of F, Cl, Br, I, —OH, —SiH₂OH, —NO₂, —CO₂H, —SO₃H, —O—SO₃H⁻, —PO₄⁻³ —O—PO₃H₂⁻, —PO₃H₂, —NH₃⁺, —CH₃, —CH₂C₆H₅, -3,4-dihydroxyphenyl, —CH₂-3,4-dihydroxyphenyl, —NR′R″ where R′ and R″ are each independently selected from H, —CH₃, —CH₂CH₃ and —CH₂C₆H₅ or substituted benzyl or mono-, di-, tri-hydroxyl benzyl;

each R³ is independently H or is selected from the group consisting of —CO₂H, —SO₄H, —SO₃H, —PO₄H, —NH₃⁺, —CH₃, —CH₂CH₃, —CH₂C₆H₅ or substituted benzyl or mono-, di-, tri-hydroxyl benzyl; and

each X⁻ is independently a counter anion selected from the group consisting of Cl⁻, Br⁻, I⁻, —SO₄⁻² and —PO₄⁻³, acetate, benzoate and lauryl-sulfate.

In yet another aspect of the method, the adhesive comprises the formulae C¹, C², C³, C⁴, C⁵ and C⁶:

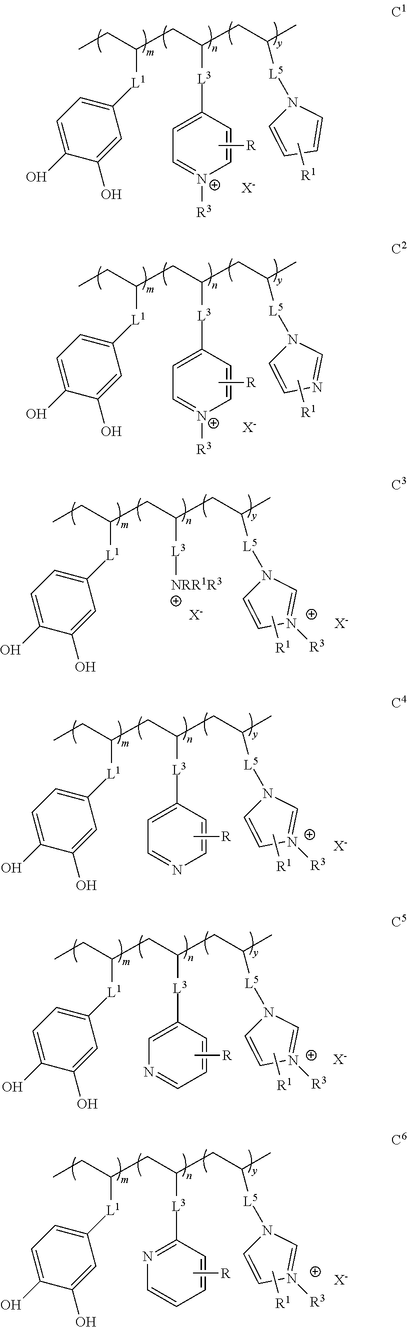

wherein: each m, n and y is independently 100 to 10,000,000;

each L¹, L³ and L⁵ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;

each R and R¹ is independently H or is selected from the group consisting of F, Cl, Br, I, —OH, —SiH₂OH, —NO₂, —CO₂H, —SO₃H, —O—SO₃H⁻, —PO₄⁻³, —O—PO₃H₂⁻, —PO₃H₂, —NH₃⁺, —CH₃, —CH₂C₆H₅, -3,4-dihydroxyphenyl, —CH₂-3,4-dihydroxyphenyl, —NR′R″ where R′ and R″ are each independently selected from H, —CH₃, —CH₂CH₃ and —CH₂C₆H₅ or substituted benzyl or mono-, di-, tri-hydroxyl benzyl;

each R³ is independently H or is selected from the group consisting of —CO₂H, —SO₄H, —SO₃H, —PO₄H, —NH₃⁺, —CH₃, —CH₂CH₃, —CH₂C₆H₅; and each X⁻ is independently a counter anion selected from the group consisting of Cl⁻, Br⁻, I⁻, —SO₄⁻² and —PO₄⁻³; acetate, benzoate and lauryl-sulfate.

In yet another aspect of the method, B, N and Y are each independently an aryl or a substituted aryl group. In another aspect of the above method, each R, R¹, R² and R³ is independently hydrogen or a substituted aryl group. In another aspect of the method, at least one of A, B, M, N, X and Y is independently selected from the group consisting of the formulae:

-L¹-COOH, -L¹-O—SO₃H, -L¹-SO₃H, -L¹-O—PO₃H₂ and -L¹-NH₃⁺;

-L³-COOH, -L³-O—SO₃H, -L³-SO₃H, -L³-, —O—PO₃H₂ and -L³-NH₃⁺; and

-L⁵-COOH, -L⁵-O—SO₃H, -L⁵-SO₃H, -L⁵-, —O—PO₃H₂ and -L⁵-NH₃⁺;

wherein each L¹, L³ and L⁵ is independently selected from a bond, —CH₂—, —O—, —S— and —NR′— where R′ is selected from H, —CH₃, —CH₂CH₃ and —CH₂C₆H₅.

In yet another aspect of the method, each of B, N and Y independently comprises a derivative of the formulae:

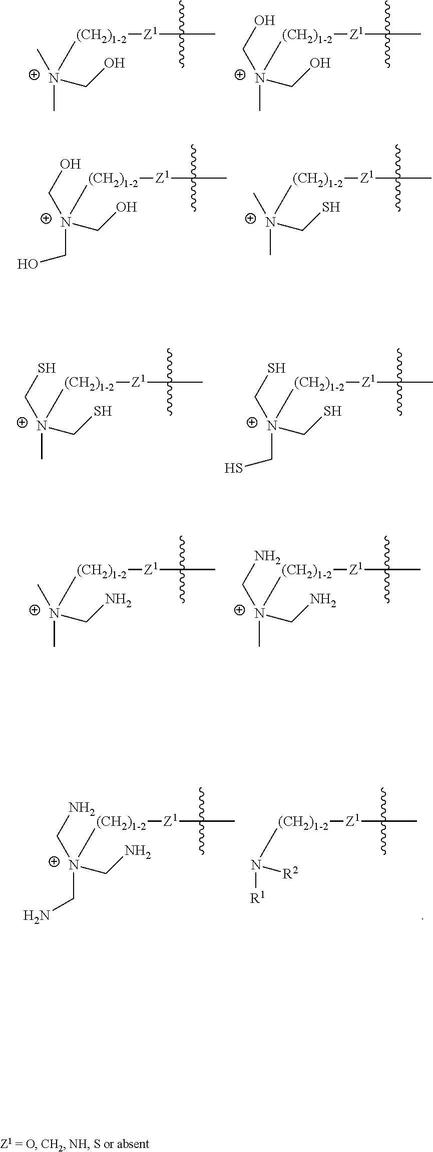

In yet another aspect of the method, each of B, N and Y is independently selected from the group consisting of the formulae:

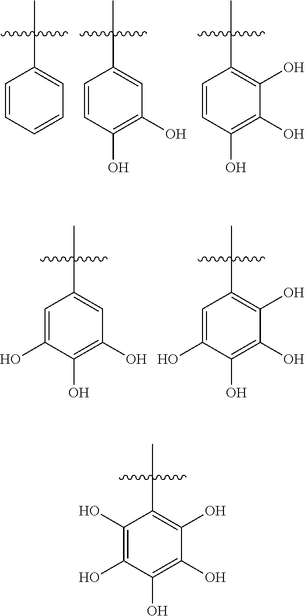

In yet another aspect of the method, at least one of A, M and X is independently selected from the group consisting of the formulae:

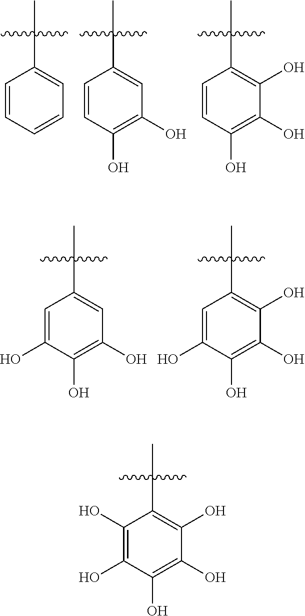

In yet another aspect of the method, the adhesive is enhanced in moisture, in water or in salted water. In another aspect, the surface is selected from the group consisting of human skin, wood, paper, leather, metal, plastic, foam, glass, plaster and fabric. In another aspect of the method, the grip or tackiness of the surface is maintained even with slippery or sweaty skin. In another aspect, the solvent is selected from the group consisting of methanol, ethanol, propanol, isopropanol, acetone, THF, MEK, MIBK, MTBE, water, salted water, or mixtures thereof. In one variation, the adhesive may be used to enhance tackiness, gripping or control of a bat in a game of baseball or softball, in holding and throwing balls, such as baseball, football or for a goalie in a soccer game. In another variation, the adhesive may be used to enhance tackiness, gripping or control of a handle such as a paddle for table tennis, a tennis racket, a golf club, a surf board or a push off board or starting block for competitive swimming, etc.

In another variation of the method, the adhesive may be used to enhance gripping and control when wall climbing or rock climbing, rope climbing, when used with or without a glove, such as a baseball or softball batting glove, golf glove and football glove, or when using a glove for auto racing. In another variation, the adhesive is formulated as a gel for topical application on the surface. In one variation, the adhesive auto-activates when placed in contact with moisture containing salts, or with salty moisture or water such as sweat. In another variation of each of the above method, the adhesive is an antibacterial adhesive, an antifungal adhesive or an antiviral adhesive.

In one variation, at least one, two or three of L¹, L², L³, L⁴, L⁵ and L⁶, and A, B, M, N, X and Y are present. As used herein, an asymmetric linker (e.g., L¹, L² etc) or group designated as “—C(O)O—” for example, represents both the divalent groups “—C(O)O—” and “—OC(O)—” that may be inverted and may attach or link in both directions.

In one variation of the adhesive, the molar ratio of the monomer in the copolymer is 1:1, or 1:1:1. In another variation of the adhesive, the ratio of m:n is 1:1; and the ratio of m:n:y is 1:1:1. In another variation, m+n=100 mol %; m: 100-0 mol %; n: 0-100 mol %. In another variation, m+n+y=100 mol %; m: 100-0, n: 0-100 and z: 0-100.

In one variation of the above adhesive, the adhesive is formulated in a polar solvent, such as alcohol, water and mixtures thereof. In another variation of the above, -(A)ₐ- is not a group selected from anammonium, imidazolium or pyridinium group. In another variation, -(A)ₐ- is a group selected from quinolinium, isoquinolinium, phenathridinium, phenanthrolinium, pyrimidinium, benzothoazolinium, benzothiadiazolinium, purinium, pyrazinium or acridinium. In another variation of the above, the polymer is prepared from a monomer; and is not a copolymer.

It is noted that the above depiction of the copolymers, designated as the -L¹-(A)ₐ-L²-(B)_{b} monomer and the -L³-(M)ₘ-L⁴-(N)ₙ monomer, the designation is used only to distinguish the structures and functional groups of the linkers and functional groups, and is not intended to show any particular sequence of the copolymers. The copolymers may be random, alternating, statistical, periodic and block copolymers. In another variation, at least one of -(A)ₐ-, -(M)ₘ- and —(X)ₓ— is independently selected from the group consisting of quinolinium, isoquinolinium, phenathridinium, phenanthrolinium, pyrimidinium, benzothoazolinium, benzothiadiazolinium, purinium, pyrazinium or acridinium. In another variation, the polymer is prepared from a monomer; and is not a copolymer.

In one variation of the adhesive, each B, N and Y is independently selected from the group consisting of phenyl, 2,3-dihydroxyphenyl, 2,3,4-trihydroxyphenyl, 3,4,5-trihydroxyphenyl, 2,3,4,5-tetrahydroxyphenyl, 2,3,4,5,6-pentahydroxyphenyl, 2,3-dicarboxyphenyl, 2,3,4-tricarboxyphenyl, 3,4,5-tricarboxylphenyl, 2,3,4,5-tetracarboxyphenyl, 2,3,4,5,6-pentacarboxyphenyl, 2,3-disiloxyphenyl, 2,3,4-trisiloxyphenyl, 3,4,5-trisiloxyphenyl, 2,3,4,5-tetrasiloxyphenyl and 2,3,4,5,6-pentasiloxyphenyl.

As depicted in this application, a group represented by the structure B³, for example,

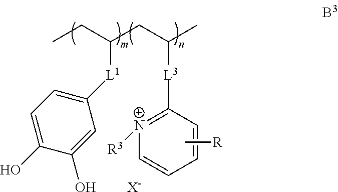

where the substituent —R is attached between 2 carbon atoms on the pyridinium ring means that —R may be attached at any available position on the pyridinium ring, such as the 3-, 4-, 5- or -6 position.

In one variation of the above compounds, R, R¹, R² and R³ are not H. In one variation of the above, b is 0. In another variation, n is 0. In another variation, b and n are both 0. In another variation, b is 1 and n is 0. In another variation, b is 1 and n is 1.

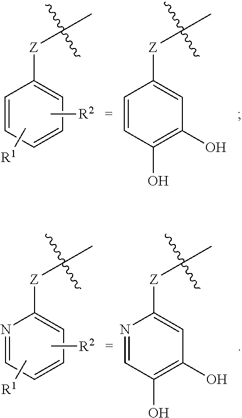

In one variation of the method, the adhesive is a compound, composition or a polymer as disclosed herein.

### DETAILED DESCRIPTION OF THE INVENTION

### Definition

The term “copolymer” means a polymer that is made from two or more different monomers. Examples of such monomers may include ethylene, styrene and acrylonitrile, and their substituted derivatives. For example, two different monomers may be allowed to polymerize in a reaction medium such that a copolymer is formed that contains both residues of the two different monomeric units. In one aspect, the copolymer may be a random copolymer having no definitive sequence of the monomer units. In another aspect, the copolymer may be a regular copolymer with regular alternating sequence of two monomer units. In another aspect, the copolymer may be a block copolymer containing a block of one monomer connected to a block of another monomer.

The total number average molecular weight (Mnₜ) of the polymers or block polymers or copolymers of the present invention is typically provided in various ranges, of from about 5,000 to 6,000, 6,000 to 8,000, 8,000 to 10,000, 10,000 to 12,000, 28,000 to 30,000, 43,000 to 45,000, 53,000 to 55,000, 58,000 to 60,000, 78,000 to 80,000, 88,000 to 90,000, 97,000 to 100,000, 115,000 to 120,000, 125,000 to 130,000, 135,000 to 140,000, 145,000 to 150,000, 200,000 to 400,000, 400,000 to 500,000, 500,000 to 600,000, 600,000 to 700,000 or about 700,000 to about 1,000,000, or to 10,000,000; and as disclosed herein. The Mn may be determined standard methods employed in the art, such as by using chromatography such as gel permeation chromatography (GPC). The molecular weight of the block copolymer and properties obtained are dependent upon the molecular weight of each of the polymers or polymeric blocks.

The term “homopolymer” means a polymer that are formed by the reaction starting with the same monomer. Homopolymers may include addition polymers that are polymers or macromolecules that are formed by the addition reaction of olefins, acetylenes, aldehydes or other compounds having an unsaturated bond or functional group. Representative homopolymers from monomers include polyethylene from ethylene, poly(vinyl chloride) from vinyl chloride, polyacrylonitrile from acrylonitrile, polystyrene from styrene etc.

The term “monomer” means any substance or molecule that can be converted or made into a polymer. Examples of such monomers may include ethylene, styrene and acrylonitrile. Monomers may also refer to dimers or trimers, if for example, the dimers or trimers can also undergo further polymerization.

“Optionally substituted” means a group, such as an alkyl group, an aryl group, a heteroaryl group, as disclosed herein, may be substituted by one or more substituents selected from halogen (—F, —Cl, —Br— or —I), —OH, —SH, —SiH₂OH, —NH₂, —NO₂, —CH₃, —CF₃, —OCH₃ and —OCF₃. For example, an optionally substituted or substituted benzyl or mono-, di-, tri-hydroxyl benzyl group substituted with 1 substituent selected from the group consisting of halogen (—F, —Cl, —Br— or —I), —OH, —SH, —SiH₂OH, —NH₂, —NO₂, —CO₂H, —O—SO₃H, —SO₃H, —O—PO₃H₂, —PO₃H₂, —NH₃⁺, —CH₃, —CF₃, —OCH₃ and —OCF₃.

The term “polymer” means a molecule having a structure that is composed of multiple repeating units, and may refer to a substance or molecule with high molecular weight. Representative of such polymers may include linear polymers comprising a long chain of skeletal atoms to which are attached substituents or substituent groups; branched polymers that may be linear polymers with branches of the same or similar basic structure as the main chain; or cross-linked or network polymers where chemical linkages are present between the chains of the polymers. The polymers or copolymers may be random copolymers, alternating copolymers (e.g., regular alternating A and B monomers), periodic copolymers, statistical copolymers or block copolymers.

The term “random” polymers or copolymers are polymers in which the monomer units are incorporated into the chain wherein there can exist various combinations of ordering including block polymer units where, for example, either the first monomeric unit or second monomeric unit (or third unit, fourth unit etc . . . , as provided herein) or both units may be repeated and are adjacent to one another. “Alternating” first monomeric and second monomeric copolymers are those in which the first monomeric and second monomeric units occur in repeating alternate sequences on the polymer chain in atactic structures (such as isotactic or syndiotactic) or in combinations of the general formula as described herein, wherein x and y are integers from 1 to 10,000.

In one embodiment, the present application discloses cationic or amphilic ionic copolymer-containing heterocycles and heterocyclic salts such as pyridines and substituted pyridines, pyridinium salts, substituted pyridinium salts, imidazoles and substituted imidazoles, imidazolium salts and substituted imidazolium salts, epoxides, glycidolderivatives, hydroxy aromatics, hydroxy phenols, polyhydroxy phenols, catechol and substituted catechol monomers which can undergo multiple continous phase inversion in saline water and may be solidified into an adhesive such as a wet adhesive or wet glue that may be used for improving tackiness, traction, grip or control of a surface. In another embodiment, there is provided the heterocyclic salts in combination with imidazoles and substituted imidazoles, imidazolium salts and substituted imidazolium salts, epoxides, glycidol derivatives, hydroxy aromatics, hydroxy phenols, polyhydroxy phenols, catechol and substituted catechol monomers. These ionic polymer glues can adhere and adsorb onto various different surfaces. The bonding strength of these ionic polymer glue can be further enhanced through secondary crosslinking with another functional group, for example, by oxidative crosslinking of a functional group, such as catechol, cationic, anionic radical polymerization of epoxides, acrylates, methacrylates; coupling/crosslinking of epoxides, arylates, methacrylates, aldehydes, N-succinimidyl group, etc., and at different pH, such as at pH>6 conditions.

In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited in this specification, including the Background, Detailed Description sections and Examples, are incorporated by reference into this disclosure as if each had been individually incorporated.

Some embodiments in the present application are directed to polymers, such as ionic polymers, that may be used under moist or wet conditions. In one embodiment, the strength of the adhesive can be further enhanced through the oxidative crosslinking of monomers, such as catechol monomers, at pH 8-9. In one aspect, x, z are monomer molar ratio of the imidazolium and catechol monomers in the ionic polymer. In some embodiments, the adhesive polymer orionic polymer glue of the present application may be crosslinked or further cured, as disclosed herein. In one variation, the polymer may be crosslinked with aqueous oxidizing agents, or in pH>6 environments or conditions.

General Scheme for the Preparation of Representative Polymers:

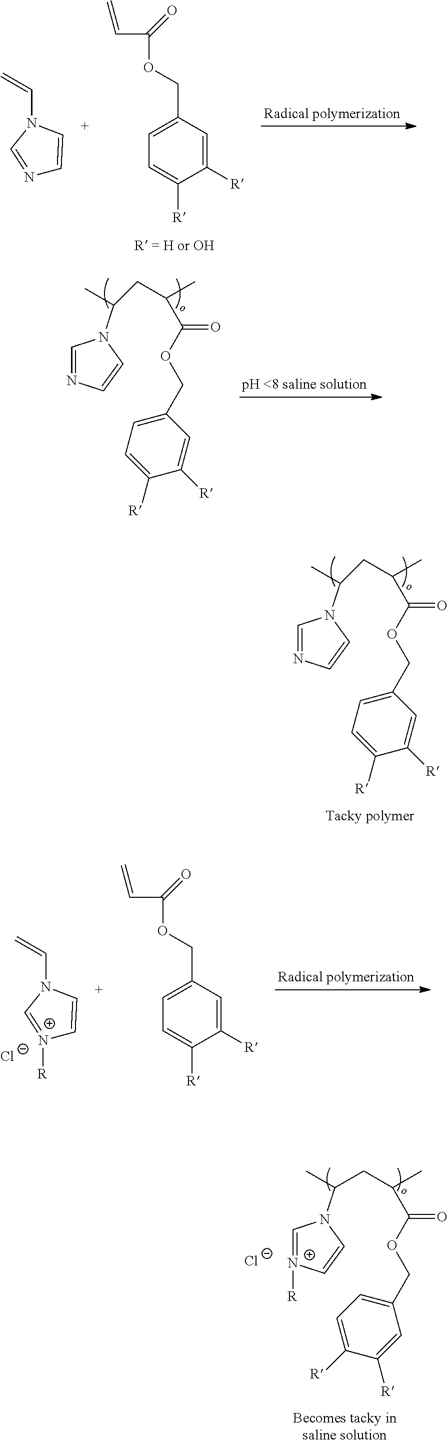

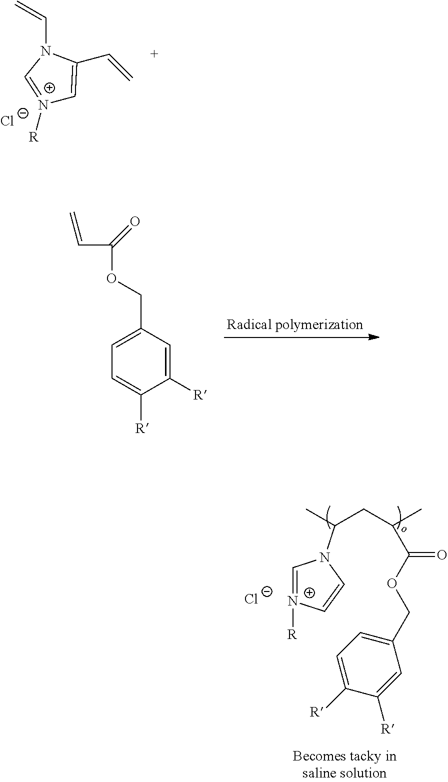

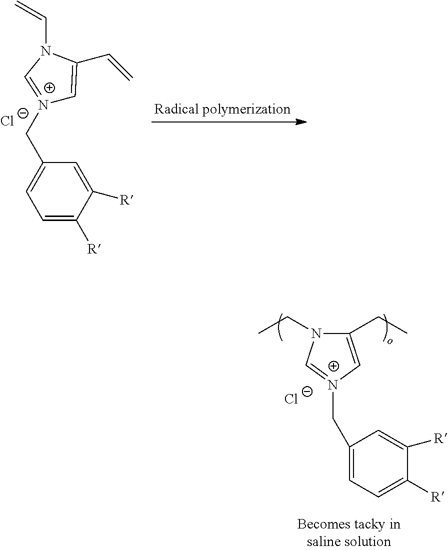

### EXPERIMENTAL

The procedures for the preparation of the homopolymers or copolymers are based on a related process for the preparation of highly conductive, mesoporous, graphitic nanostructures as described in J. Yuan et al., Chem. Mater. 2010, 22, 5003-5012.

### General Procedure:

The co-monomers (for example protected catechol acrylate and 2-diethylaminoethyl acrylate) are mixed in accordance with the desired molar ratios for each application, along with a catalyst (for example, 0.01 equiv of a radical photoinitiator, e.g., acrylic acid and azobisisobutyronitrile (AIBN)) dissolved in desired solvent such as toluene/THF for non-polar co-monomers or DMF/diglyme/water for polar co-monomers.

In one particular process of using the copolymers, such as polymers comprising catechol cationic copolymers, the copolymers are prepared from a protected catechol acrylate due to the spontaneous autoxidation of the catechol functional group, or the reactions are carried in acidic conditions to generate a reducing environment (pH<5.5) for catechols. In one method, where the protecting groups are present, the silyl-protecting groups are later cleaved in an aqueous pH<3 solution at room temperature.

Visible or UV light curing system: For further crosslinking of acrylate side groups of non-acrylate copolymers (e.g., polyester with acrylate side chains) to enhance cohesion of glues, visible or UV radical polymerization are carried out.

Hand peel test: Once each adhesive film is prepared on PET backing and tested by hand. The stickiness or adhesive property of the tapes in water is stronger than stickiness of 3M Scotch packing tapes in dry ambient condition.

### Synthesis of Homopolymer (HP-1):

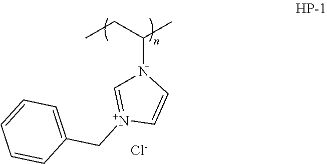

Into a 50 mL flask equipped with a magnetic stir bar under nitrogen is added the monomer 1-vinyl-3-benzyl imidazolium chloride (M1, 5 g). The monomer is dissolved in 50 mL of DMSO with stirring. Azobisisobutyronitrile (AIBN) initiator (100 mg) is added into the solution mixture. The solution is stirred at 90° C. for 20 h. The resulting solution is added dropwise to a 250 mL flask containing 150 mL THF for purification via re-precipitation. After addition of the solution, the precipitate is formed in the 250 ml flask. The precipitate is filtered from the THF solution and added to a 500 mL flask containing a magnetic stir bar. Methanol (45 mL) is added to the flask with stirring until the precipitate dissolved. The solution is then stirred at room temperature, and THF is added dropwise for precipitation. The precipitated product is filtered and dried at about 90° C. under high vacuum (3-10 mbar) for 12-14 hrs to obtain 5 g of a solid, HP-1.

### Synthesis of Homopolymer (HP-2):

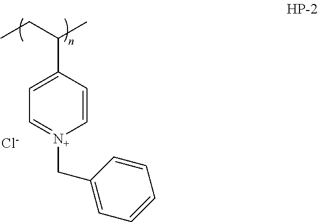

Into a 50 mL flask equipped with a magnetic stir bar under nitrogen is added the monomer 4-vinyl-1-benzylpyridinium chloride (M3, 5 g). The monomer is dissolved in 50 mL of DMF. Azobisisobutyronitrile (AIBN) initiator (100 mg) was added into the solution. The solution is then stirred at 90° C. for 20 h. The mixture is cooled to room temperature. Polymer is then precipitated and dried as described in the above procedure. About 5 g of HP-2 is obtained after the purification

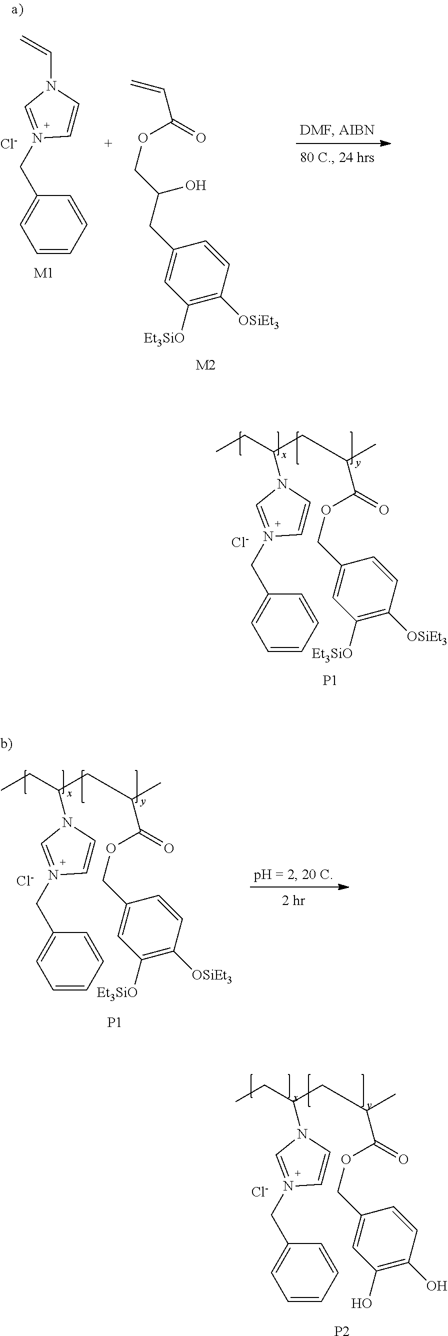

wherein x and y define the block polymer and are integer greater than 1.

### FIG. 1. Synthesis of Copolymer P2

### Synthesis of Copolymer, P2:

Both monomers M1 and M2 are prepared according to literature methods. See for example, J. Yuan et al., Chem. Mater. 2010, 22, 5003-5012. 1-Vinyl-3-benzyl imidazolium chloride (monomer M1, 1 g) and silyl protected catechol acrylate derivative (monomer M2, 0.3 g) are added to a 250 mL 3-N RBF with a magnetic stir bar under nitrogen. The monomers are dissolved in N,N-dimethylformamide (DMF, 10 mL) and stirred at room temperature for about 15 minutes. Azobisisobutyronitrile (AIBN) initiator (13 mg) is added into the solution mixture, and the reaction mixture is stirred and heated to 80° C. for 24 h (FIG. 1). After the reaction is completed, the solution is transferred to a 500 mL RBF. Diethyl ether (150 mL) is added to the stirred reaction mixture to precipitate out the crude polymer product, P1. The resulting mixture with the solid precipitate is stirred at room temperature for 15 mins and DMF (10 mL) is added to re-dissolve the solids. To the stirred mixture is slowly added diethyl ether (150 mL) to re-precipitate the polymer. Unreacted monomers are dissolved in the diethyl ether and are removed from the product.

The precipitated polymer is filtered with a Buchi filter funnel using Whatman paper, and the solid polymer is washed with 30 mL diethyl ether and air dried for about 1 hour. The dried polymer is transferred to a 250 mL RBF and water (10 mL) is added with stirring to dissolve the polymer. To the stirred aqueous solution of the polymer at room temperature is added 50 mL of aqueous HCl (pH=2, 0.01 M HCl prepared by dissolving 1 mL 0.5 M HCl (Sigma Aldrich) in 49 mL DI water) and stirred for 2 h, and dialyzed thoroughly as follows. The P1 polymer solution is added into dialysis tube (molecular weight cutoff: 1000), and is dialyzed against DI water (1 L) for 72 h, during which the water is exchanged with fresh DI water for 5 times. The purified polymer P1 is obtained after freeze drying as follows. P1 polymer solution is freezed at −30° C. and subsequently dried under vacuum (300 Pa pressure) for 24 h. Synthesis of Copolymer P3 and Epoxy Curing to Form Copolymer P4:

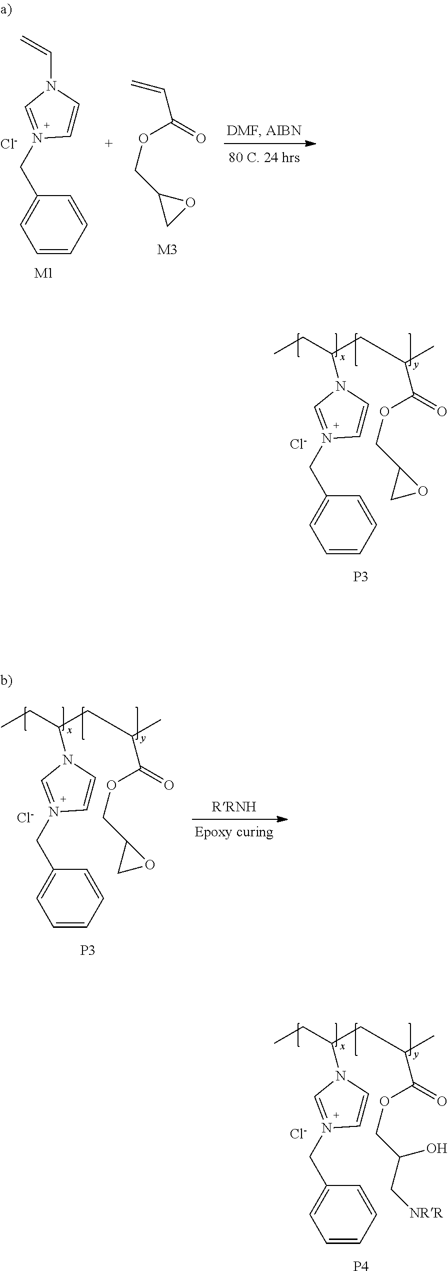

wherein: x and y define the block polymer and are integer greater than 1; and R and R′ are each independently H, C₁-C₆alkyl, —CH₂C₆H₅ wherein the alkyl and the C₆H₅ are optionally substituted by 1 or 2 substituents selected from the group consisting of halogen (—F, —Cl, —Br— or —I), —OH, —SH, —SiH₂OH, —NH₂, —NO₂, —CH₃, —CF₃, —OCH₃ and —OCF₃.

### FIG. 2. Synthesis of Copolymer P3 and Epoxy Curing to Form P4

### Synthesis of Copolymer P3:

Both monomers M1 and M3 are prepared according to literature methods. See for example, J. Yuan et al., Chem. Mater. 2010, 22, 5003-5012. 1-Vinyl-3-benzyl imidazolium chloride (monomer M1, 1 g) and glycidyl vinyl acetate (monomer M3, 0.2 g) are added to a 250 mL 3-N RBF with a magnetic stir bar under nitrogen. The monomers are dissolved in N,N-dimethylformamide (DMF, 10 mL) and stirred at room temperature for about 15 minutes. Azobisisobutyronitrile (AIBN) initiator (13 mg) is added into the solution mixture, and the reaction mixture is stirred and heated to 80° C. for 24 h (FIG. 2). After the reaction is complete, the solution is transferred to a 500 mL RBF. Diethyl ether (150 mL) is added to the stirred reaction mixture to precipitate out the crude polymer product, P3. The resulting mixture with the solid precipitate is stirred at room temperature for 15 mins and DMF (10 mL) is added to re-dissolve the solids. To the stirred mixture is slowly added diethyl ether (150 mL) to re-precipitate the polymer. Unreacted monomers are dissolved in the diethyl ether and removed from product. The precipitated polymer is filtered with a Buchi filter funnel using Whatman paper, and the solid polymer is washed with 30 mL diethyl ether and air dried for about 1 hour. The purified polymer P3 is obtained after freeze drying as follows. P3 polymer solution is freeze at −30° C. and subsequently dried under vacuum (300 Pa pressure) for 24 h.

### General Process:

A process for further crosslinking or curing process between the polymer or copolymer functional groups in the polymer chain can also effected when the polymer comprises certain crosslinkable functional groups or residues. In one embodiment, when group is a hydroxy aryl group, such as a catechol group, curing of the polymer may be performed by changing the pH of the aqueous formulation comprising the polymer to a different pH, such as a more basic pH. For example, the polymer formulation may be contacted with water or an aqueous solution at a pH of about pH of 5, pH>5, pH>5.5, pH>6, pH>6.5, pH>7, pH>7.5, pH>8, pH>8.5, pH>9 or higher.

In another embodiment of the process, the materials or the surface of the materials comprising the adhesive may be first contacted or immersed in water or in an aqueous solution, and then the pH of the resulting mixture or composition may be increased to the desired pH, depending on the nature of the polymer, the functional group and the nature of the materials being glued together. Without being bound by the proposed mechanism of action disclosed herein, it is believed that the polymer or the functional groups, such as a hydroxy aryl group, undergo a curing or crosslinking process by way of an auto-oxidative crosslinking process or may be initiated by a metal ion(s) via coordination chemistry; to form a significantly stronger adhesive when compared to the use of the adhesive without a curing step. In another embodiment where the polymer comprises a functional group or residue such as an acrylate, a methacrylate or a substituted acrylate, the polymer may be crosslinked via visible light or UV light via photoinitiated polymerization.

In another embodiment, when the polymer comprises an epoxy group, such as an epoxide or a glycidyl group, the curing step may be performed using a reagent, such as an amine. Such an amine may be a di- or tri-amine based epoxy curing agent. Amines that may be used for amine-based epoxy curing includes aliphatic amines such as diethylamine (DEA), methylamine (MA), dimethylamine (DMA), cycloaliphatic amines such as cyclohexylamine (CHA) and cyclohexylmethylamine (CHMA), and aromatic amines such as aniline (AA) and methylaniline (MAA). Such a curing process is similar to that of the method for curing epoxy resin, where the adhesive maybe prepared or mixed and cured immediately before applying the adhesive to attach two surfaces. In one method, the dried polymer is transferred to a 250 mL RBF and water (10 mL) is added with stirring to dissolve the polymer. To the stirred aqueous solution of the polymer at room temperature is added diethylamine (DEA) and allowed to cure.

Performance of Adhesive Compositions with Different Materials:

### Preparation of the Adhesive Composition:

1 g of the homopolymer or the copolymer was added into a 50 mL RBF with a magnetic stirrer. 10 mL of water was added to the homopolymer or copolymer and the resulting mixture was stirred for 15 minutes to form a milky white, relatively viscous adhesive composition. The adhesion experiments described below may employ the polymer adhesive composition.

For the copolymers that are functionalized with extra crosslinkable residues, optionally, there is a second step of curing of the adhesive composition that may be performed to increase or enhance the bonding performance. For example, in the case of the preparation of copolymers with catechol functional groups (i.e., 3,4-dihydroxyphenyl-), a catechol-mediated auto-oxidation process may be performed.

Accordingly, in addition to joining two test strips of the same or different material composition, the strips (or materials) may be immersed in water, at a pH of about 5, pH>5, pH>5.5, pH>6, pH>7, pH>8, pH>9, or pH range of 8-9, the polymer undergoes further curing or crosslinking to form a stronger adhesive. Under certain conditions, the catechol or other hydroxybenzyl or hydroxy aryl groups may undergo auto-oxidative crosslinking above neutral pH, such as pH>7.

Depending on the type or the nature of the functional groups of the polymers as described herein, the curing step may also be performed by crosslinking mechanism or chemistry. For example, where the polymer comprises a hydroxyphenyl group or dihydroxyphenyl group such as a catechol group, the crosslinking process may be initiated by a metal ion(s) by way of coordination chemistry. The pH of the solution may be lower than pH 5.5, the concentration should be considered with respect to solubility, stoichiometry, and the nature of the metal ion may affect the crosslinking process.

The adhesive may also be soluble in pure water or in the presence of saline or a saline solution. For example, the salt solution may comprise of a single salt or a mixture of salts, including NaBr, NaCl, NaI, LiBr, LiCl, LiI, CaCl₂, KI and MgCl₂ as disclosed herein. In one particular aspect, the higher salt concentration (body fluid or sea water) in the applied media will cause a drying effect of the polymer when polymer solution in pure water or aqueous salt solution at low concentration is applied to surfaces in aqueous salt solution at higher concentration such as body fluid, salt water or sea water. The adhesive or glue adhere to all the different type of materials and surfaces including tissue to tissue, tissue to metal, tissue to plastic, tissue to mineral, mineral to metal, mineral to plastic, metal to metal, metal to plastic, plastic to plastic, mineral to mineral, and among other materials in wet conditions including under water. Such materials include tissues, such as human tissues, animal tissues, skin, tooth enamel, dentine, metals such as aluminum, stainless steel, copper, brass, glass, plastic, and combinations of these materials.

### Methods of Use:

In one representative procedure, a solution of a polymeric material in a polar solvent, such as in methanol, ethanol, propanol, isopropanol, acetone, THF, MEK, MIBK, MTBE, water and salted water, or mixtures thereof, is prepared by mixing the polymeric material in the selected solvent or solvent mixture. The polymer concentration in the formulation may be employed at different concentrations, such as from about 1 w/v % to 3 w/v %, 1 w/v % to 5 w/v %, from 5% to 10%, from 10% to 20% from 20% to 50% w/v, or from about 50% to about 99 w/v %. As used herein, “salted water” is a solution of water containing a salt, such as those selected from NaCl, KCl, NaI, NaBr, CaCl₂, MgCl₂ and mixtures thereof. The concentration of the salt(s) in the solution may be from about 0.05 g/liter to 1.0 g/liter. The adhesive may be formulated as a solution, formulated as a spray, or formulated as a gel, at the above noted concentrations. In one aspect, the polymeric material may be poly(phenyl vinyl imidazole), and may be formulated under standard conditions. The resulting adhesive was administered onto a surface, such as by spraying onto a surface, a person's hand or a person's feet.

Once the formulation is applied to the desired surface, the solvent or solvent mixture is allowed to dissipate or evaporate over a period of time, such as over 1-5 seconds or longer, such as 10-20 seconds, depending on the nature of the solvent or solvent mixture, the adhesive, the temperature and humidity etc . . . , and the resulting polymer remains and cots the surface to provide improved or enhance tack or grip of the surface. Such surfaces may include, for example, a person's hand, gloves, baseball, softball, floor etc. . . . . Once the surface becomes moist or wet, such as those caused by sweaty hands, the skin surface becomes tacky.

### Other Methods of Use:

Current polymeric materials to prevent slipperiness or tapes perform poorly when the environment becomes moist or wet. The adhesive of the present application can be formulated with and/or cross-linked to current polymeric materials to enhance their wet tack or wet shear performance.

While the foregoing description describes specific embodiments, those with ordinary skill in the art will appreciate that various modifications and alternatives can be developed. Accordingly, the particular embodiments described above are meant to be illustrative only, and not to limit the scope of the invention, which is to be given the full breadth of the appended claims, and any and all equivalents thereof.

What is claimed:

1. A method for improving tackiness, traction, grip or control of a surface, the method comprises:
1) administering to the surface a composition comprising an adhesive composition and a solvent, wherein the adhesive composition comprises a polymer selected from the group consisting of the formulae A, B and C, or a mixture thereof: 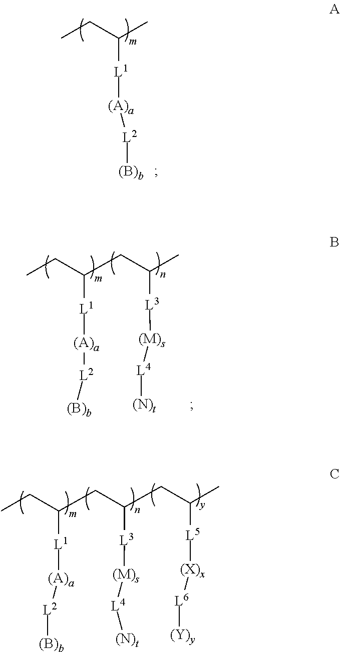
wherein:
each m, n and o is independently 100 to 10,000,000;
each a, b, s, t, x and y is independently 0, 1 or 2;
each L¹, L², L³, L⁴, L⁵ and L⁶ is independently absent or is independently selected from the group consisting of —CH₂—, —O—, —S—, —(CH₂)₁₋₂—, —CH(CH₂—)₂-, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl or mono-, di-, tri-hydroxyl benzyl, or a bond;
each A, B, M, N, X and Y is independently absent or selected from the group consisting of an aryl, substituted aryl, aryl ammonium, heteroaryl, substituted heteroaryl, heteroarylammonium X⁻ and substituted heteroarylammonium X⁻, wherein each X⁻ is independently a counter anion selected from the group consisting of Cl⁻, Br⁻, I⁻, —SO₄⁻² and —PO₄⁻³; acetate, benzoate and lauryl-sulfate;
provided that not all of L¹, L², L³, L⁴, L⁵ and L⁶, and A, B, M, N, X and Y are absent; and
2) allowing the solvent to evaporate for a sufficient period of time to allow the composition to set on the surface.

2. The method of claim 1, wherein each A, B, M, N, X and Y is independently selected from the group consisting of: 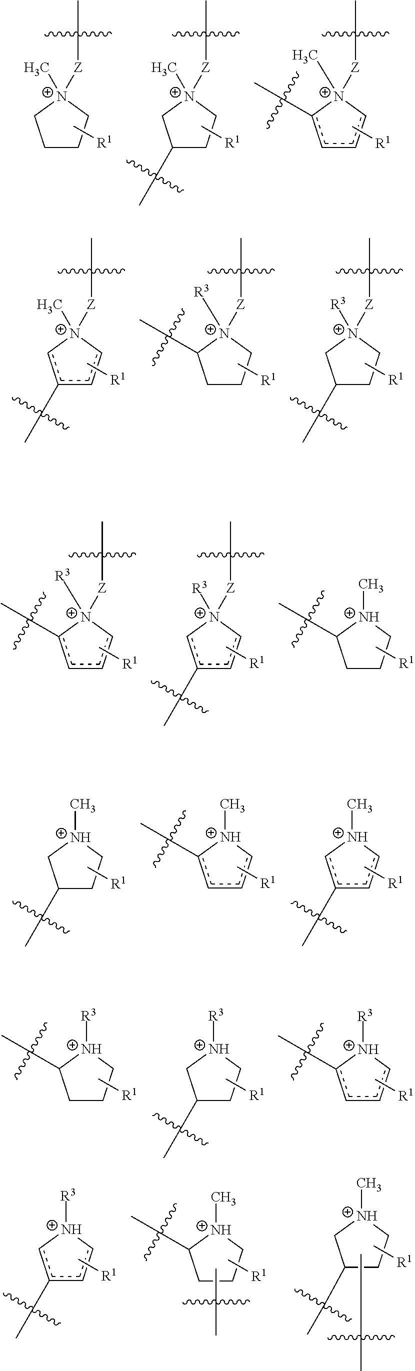 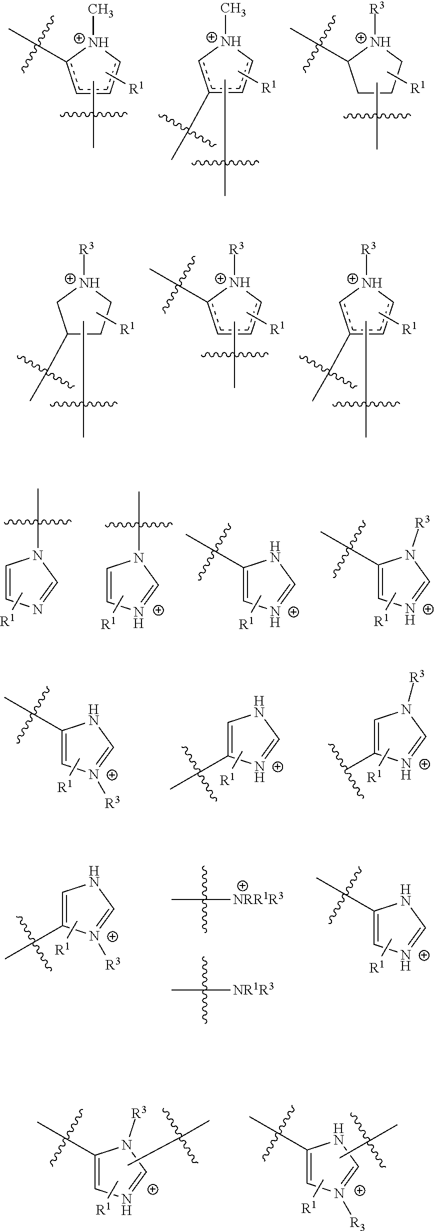 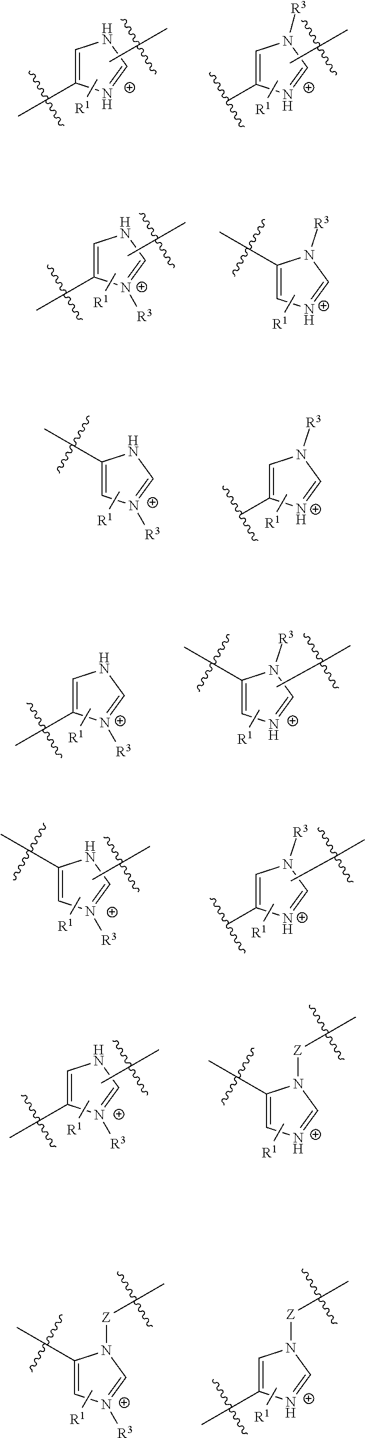 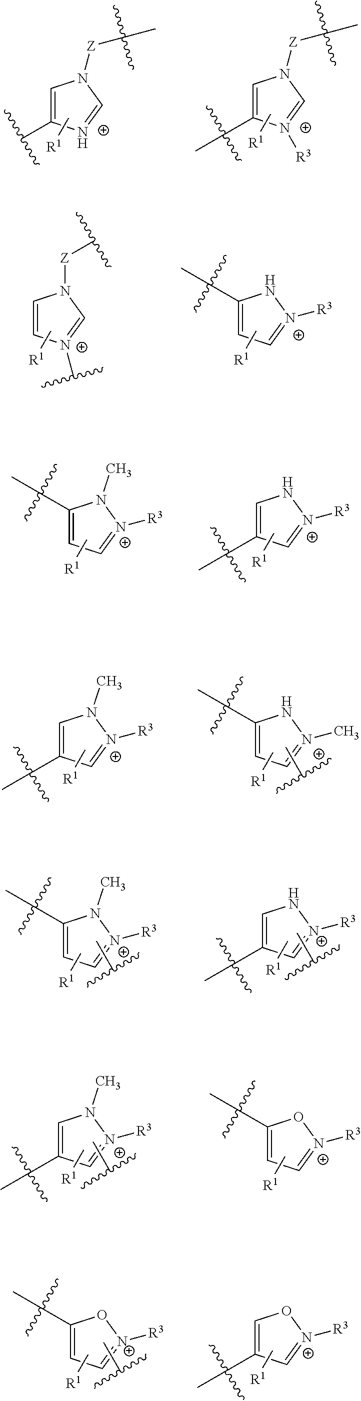 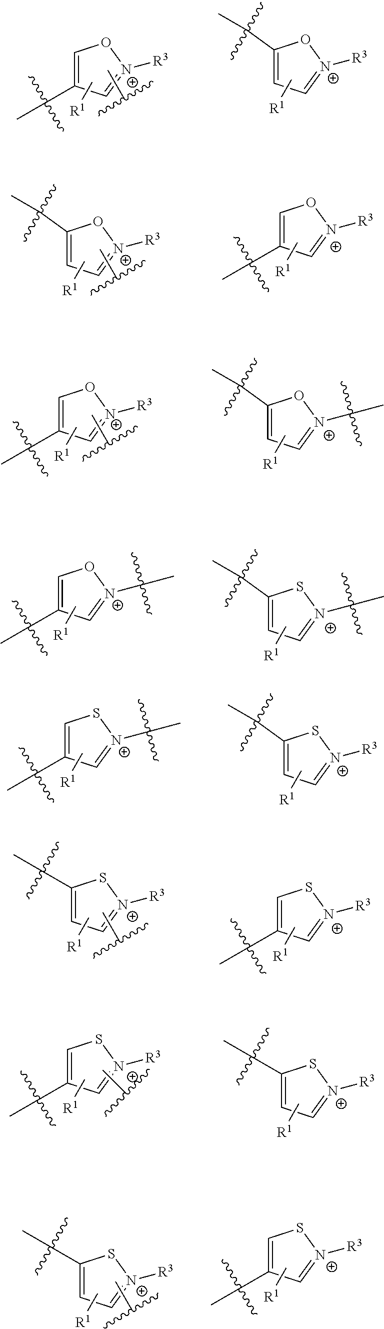 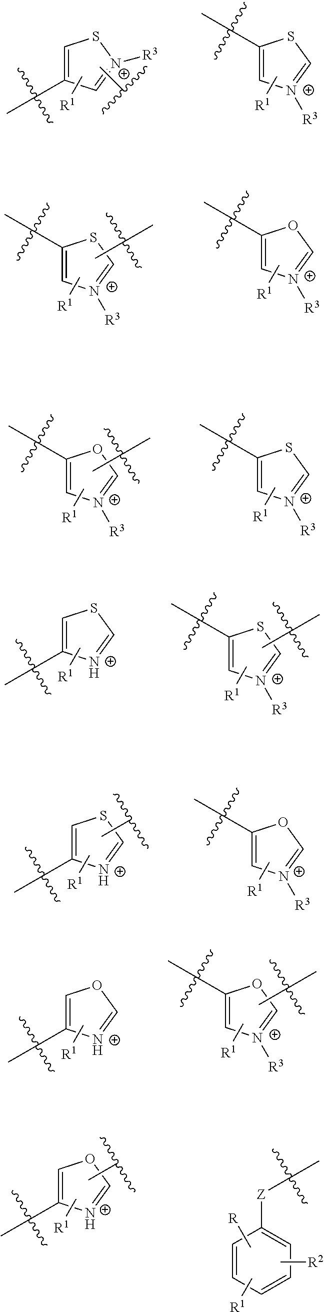 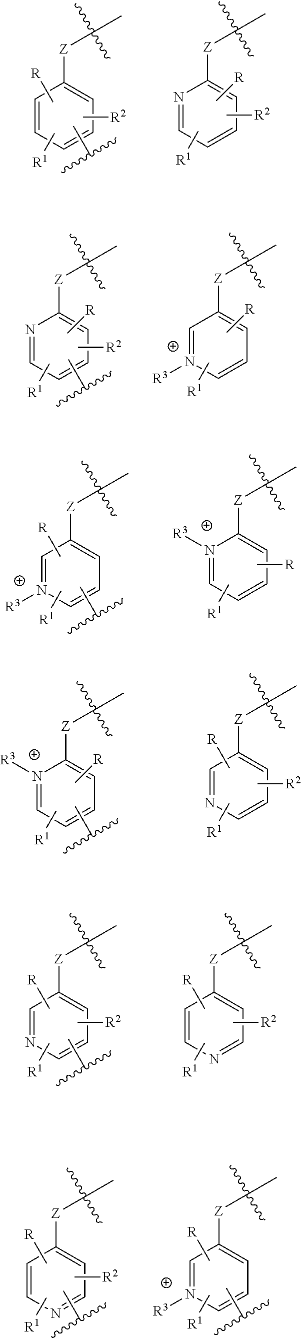 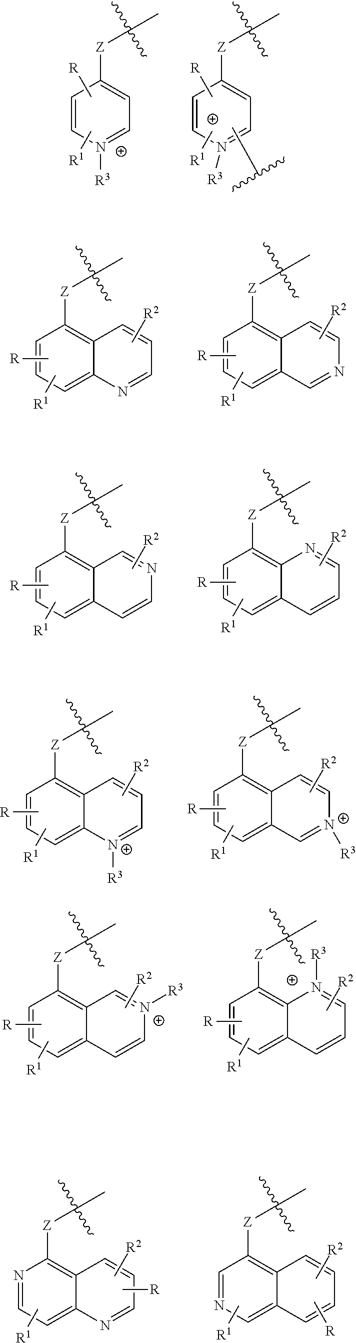 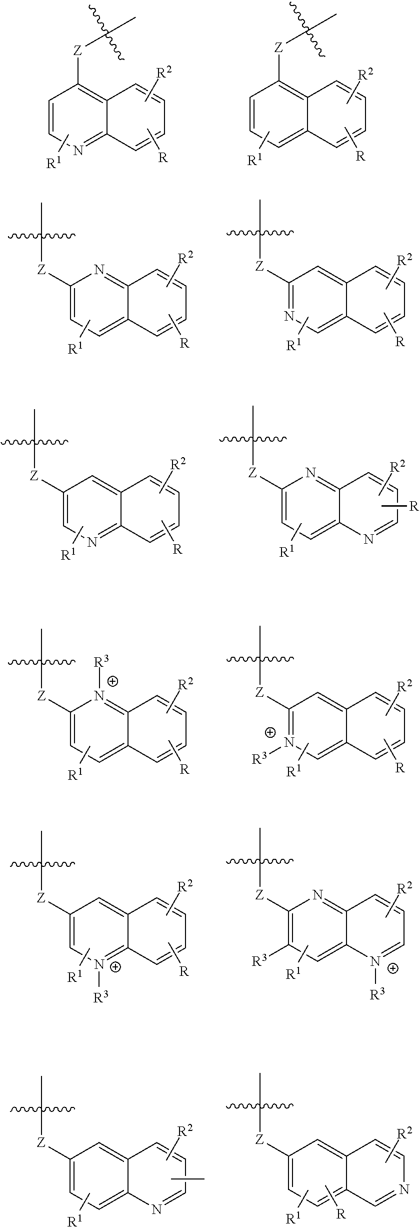 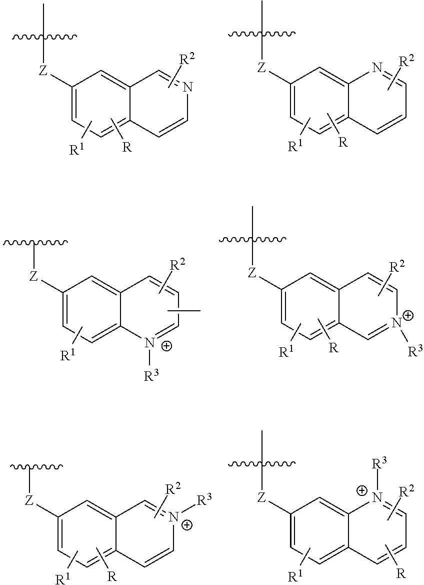
wherein:
each L¹, L², L³ and L⁴ is independently H, —CH₃, —CH₂—, —O—, —S—, —(CH₂)₁₋₂—, —CH(CH₂-)₂, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅, a bond and —NR′— where R′ is selected from H, —CH₃, —CH₂CH₃ and —CH₂C₆H₅ or substituted benzyl or mono-, di-, tri-hydroxyl benzyl or mono-, di-, tri-hydroxyl benzyl;
each R, R¹ and R² is independently H or is selected from the group consisting of F, Cl, Br, I, —OH, —SiH₂OH, —NO₂, —CH₃, a substituted aryl group, —CO₂H, —SO₄H, —SO₃H, —PO₄H, —NH₃⁺, —CH₂C₆H₅, -3,4-dihydroxyphenyl, —CH₂-3,4-dihydroxyphenyl, N-succinimidyl, —NR′R″ where R′ and R″ are each independently selected from H, —CH₃, —CH₂CH₃ and —CH₂C₆H₅ or substituted benzyl or mono-, di-, tri-hydroxyl benzyl or mono-, di-, tri-hydroxyl benzyl;
each R³ is independently H or is selected from the group consisting of —CH₃, —CH₂CH₃, a substituted aryl group, —CO₂H, —O—SO₃H, —SO₃H, —O—PO₃H₂, —PO₃H₂, —NH₃⁺ and —CH₂C₆H₅ or substituted benzyl or mono-, di-, tri-hydroxyl benzyl or mono-, di-, tri-hydroxyl benzyl; and
Z is —(CH₂)ₜ— or —(NH)— where t is 0 or 1.

3. The method of claim 1, wherein the adhesive is selected from the group consisting of the formulae A¹¹ or A¹²: 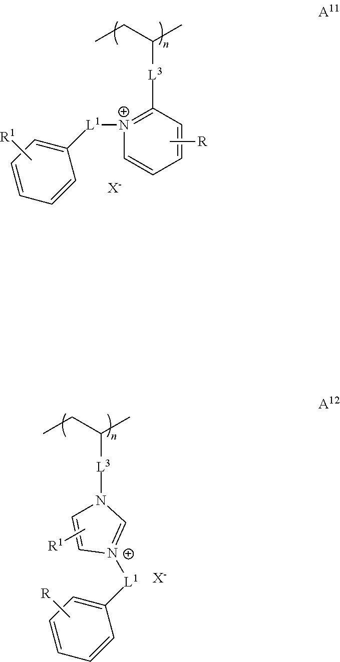
wherein:
each n is independently 100 to 10,000,000;
each L¹ and L³ is independently selected from a bond, —CH₂—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl, substituted benzyl or mono-, di-, tri-hydroxyl benzyl or mono-, di-, tri-hydroxyl benzyl;
each R and R¹ is independently H or is selected from the group consisting of F, Cl, Br, I, —OH, —SiH₂OH, —NO₂, —CH₃, —CF₃, —CO₂H, —O—SO₃H, —SO₃H, —O—PO₃H₂, —PO₃H₂, —NH₃⁺ and —NR′R″ where R′ and R″ are each independently selected from H, —CH₃, —CH₂CH₃ and —CH₂C₆H₅ or substituted benzyl or mono-, di-, tri-hydroxyl benzyl or mono-, di-, tri-hydroxyl benzyl; and
each X⁻ is independently a counter anion selected from the group consisting of Cl⁻, Br⁻ and I⁻, BF₄— and Tf₂N—.

4. The method of claim 1, wherein the adhesive is selected from the group consisting of the formulae B¹, B², B³, B⁴ and B⁵: 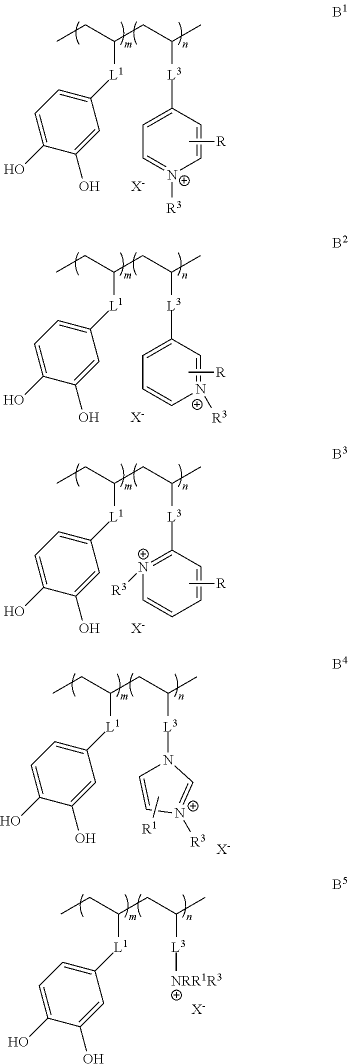
wherein:
each m and n is independently 100 to 1,000,000,000;
each L¹ and L³ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl, substituted benzyl or mono-, di-, tri-hydroxyl benzyl or mono-, di-, tri-hydroxyl benzyl;
each R and R¹ is independently H or is selected from the group consisting of F, Cl, Br, I, —OH, —SiH₂OH, —NO₂, —CH₃, —CO₂H, —O—SO₃H, —SO₃H, —O—PO₃H₂, —PO₃H₂, —NH₃⁺, —CH₂C₆H₅, - 3,4-dihydroxyphenyl, —CH₂-3,4-dihydroxyphenyl, —NR′R″ where R′ and R″ are each independently selected from H, —CH₃, —CH₂CH₃, —CH₂C₆H₅ or substituted benzyl or mono-, di-, tri-hydroxyl benzyl, substituted benzyl or mono-, di-, tri-hydroxyl benzyl or mono-, di-, tri-hydroxyl benzyl;
each R³ is independently H or is selected from the group consisting of —CH₃, —CH₂CH₃, —CO₂H, —O—SO₃H, —SO₃H, —O—PO₃H₂, —PO₃H₂, —NH₃⁺, —CH₂C₆H₅ or substituted benzyl or mono-, di-, tri-hydroxyl benzyl, substituted benzyl or mono-, di-, tri-hydroxyl benzyl or mono-, di-, tri-hydroxyl benzyl; and
each X⁻ is independently a counter anion selected from the group consisting of Cl⁻, Br⁻, I⁻, —SO₄⁻² and —PO₄⁻³.

5. The method of claim 1, wherein the adhesive is selected from the group consisting of the formulae C¹, C², C³, C⁴, C⁵ and C⁶ 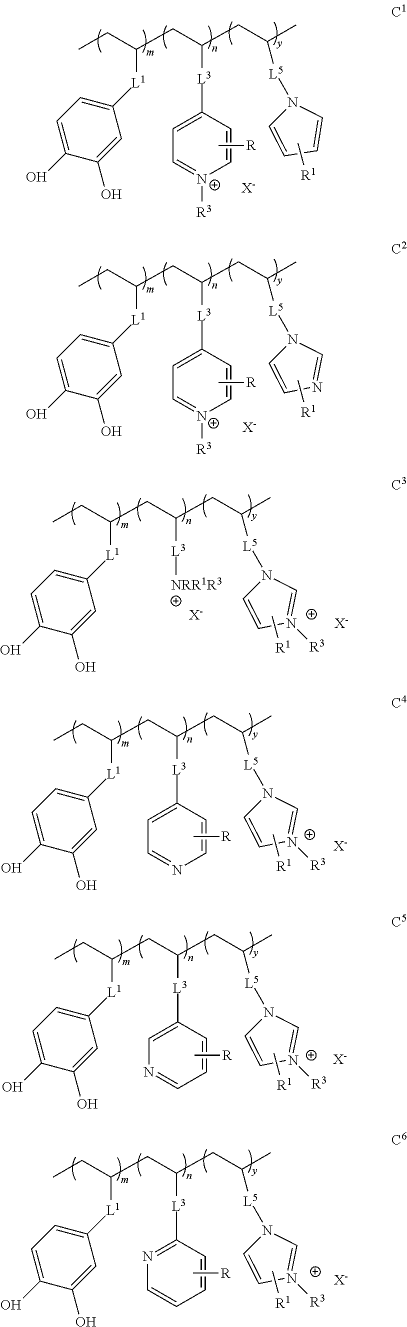
wherein:
each m, n and y is independently 100 to 1,000,000,000;
each L¹, L³ and L⁵ is independently selected from —CH₂—, —O—, —S—, —(CH₂)₁₋₂—, —CH(CH₂-)₂, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl, or a bond;
each R and R¹ is independently H or is selected from the group consisting of F, Cl, Br, I, —OH, —SiH₂OH, —NO₂, —CH₃, —CO₂H, —O—SO₃H, —SO₃H, —O—PO₃H₂, —PO₃H₂, —NH₃⁺, —CH₂C₆H₅ or substituted benzyl or mono-, di-, tri-hydroxyl benzyl, -3,4-dihydroxyphenyl, —CH₂-3,4-dihydroxyphenyl and —NR′R″ where R′ and R″ are each independently selected from H, —CH₃, —CH₂CH₃ and —CH₂C₆H₅ or substituted benzyl or mono-, di-, tri-hydroxyl benzyl;
each R³ is independently H or is selected from the group consisting of —CH₃, —CH₂CH₃, —CO₂H, —O—SO₃H, —SO₃H, —O—PO₃H₂, —PO₃H₂, —NH₃⁺ and —CH₂C₆H₅; and
each X⁻ is independently a counter anion selected from the group consisting of Cl⁻, Br⁻, I⁻, —SO₄⁻² and —PO₄⁻³.

6. The method of claim 1, wherein B, N and Y are each independently a substituted aryl group.

7. The method of claim 1, wherein the substituted aryl group is selected from the group consisting of: 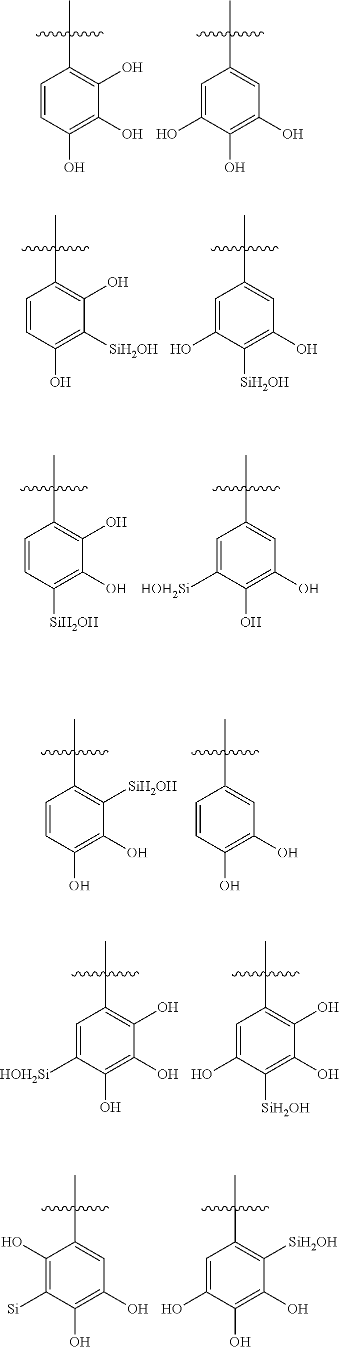 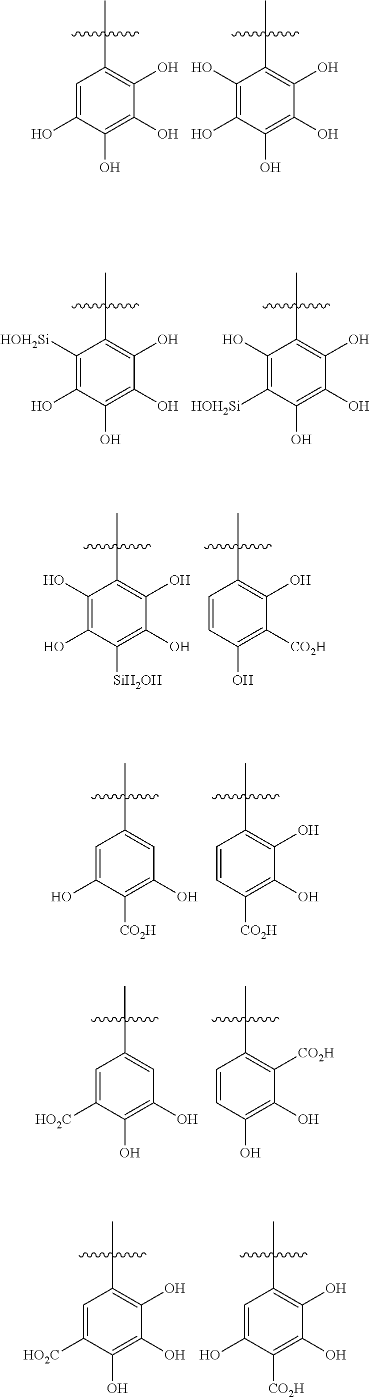 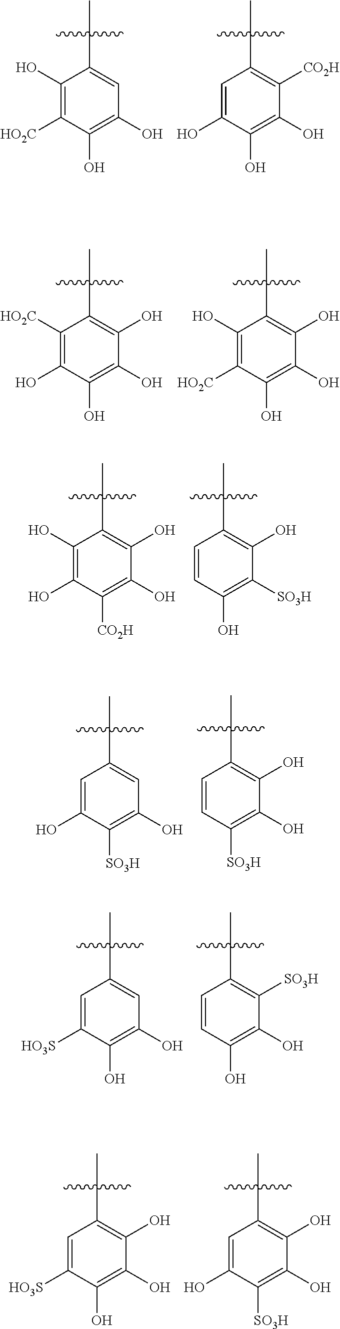 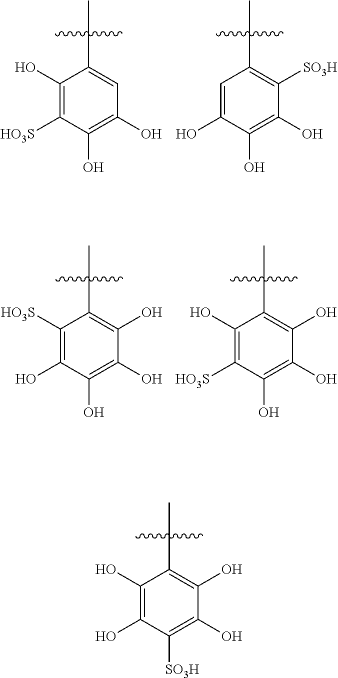
and b, n and y is 1 or 2.

8. The method of claim 1, wherein the adhesive is selected from the group consisting of the formulae A¹, A², A³, A⁴, A⁵, A⁶, A⁷, A⁸, A⁹, A¹⁰, A¹¹, A¹², A¹³ and A¹⁴: 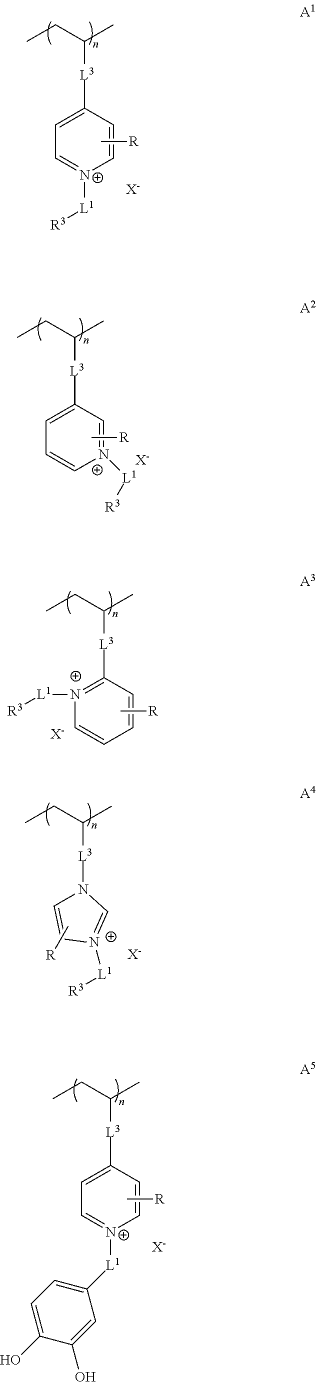 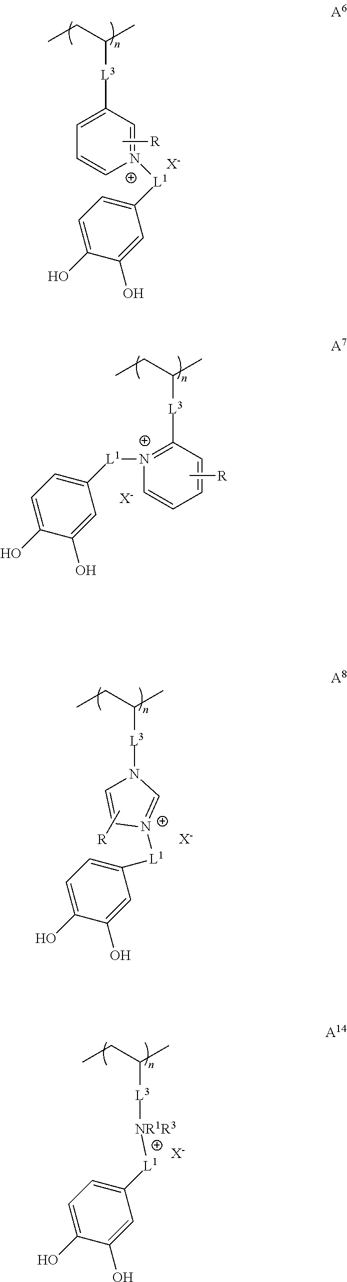 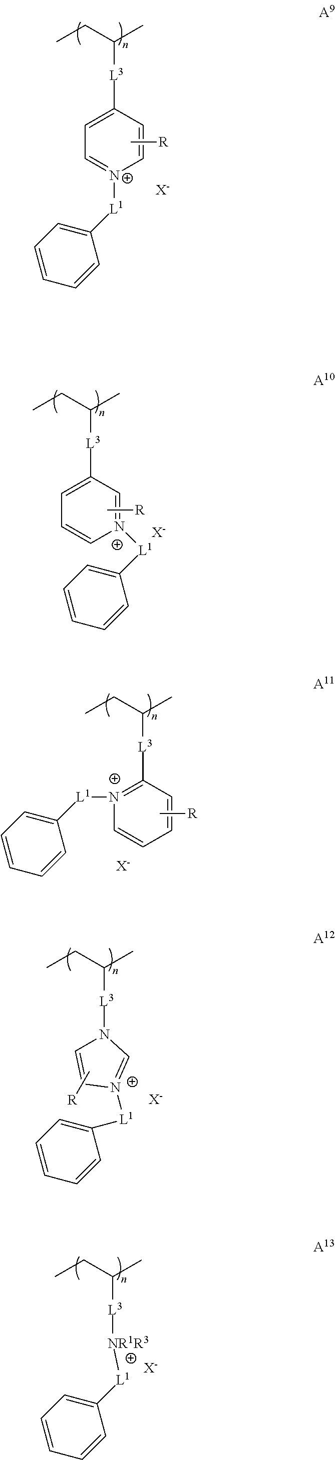
wherein:
each n is independently 100 to 10,000,000;
each L¹ and L³ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;
each R and R¹ is independently H or is selected from the group consisting of F, Cl, Br, I, —OH, —SiH₂OH, —NO₂, —CH₃, —CO₂H, —O—SO₃H, —SO₃H, —O—PO₃H₂, —PO₃H₂, —NH₃⁺, —CH₂C₆H₅, - 3,4-dihydroxyphenyl, —CH₂-3,4-dihydroxyphenyl, —NR′R″ where R′ and R″ are each independently selected from H, —CH₃, —CH₂CH₃ and —CH₂C₆H₅ or substituted benzyl or mono-, di-, tri-hydroxyl benzyl;
each R³ is independently H or is selected from the group consisting of —CH₃, —CH₂CH₃ and —CH₂C₆H₅ where the C₆H₅ group is optionally substituted with 1 substituent selected from the group consisting of halogen (—F, —Cl, —Br— or —I), —OH, —SH, —SiH₂OH, —NH₂, —NO₂, —CO₂H, —SO₄H, —SO₃H, —PO₄H, —NH₃⁺, —CH₃, —CF₃, —OCH₃ and —OCF₃; and
each X⁻ is independently a counter anion selected from the group consisting of Cl⁻, Br⁻, I⁻, —SO₄⁻² and —PO₄⁻³.

9. The method of claim 4, wherein the adhesive comprises of the formulae B¹, B², B³, B⁴, B⁵ and B⁶: 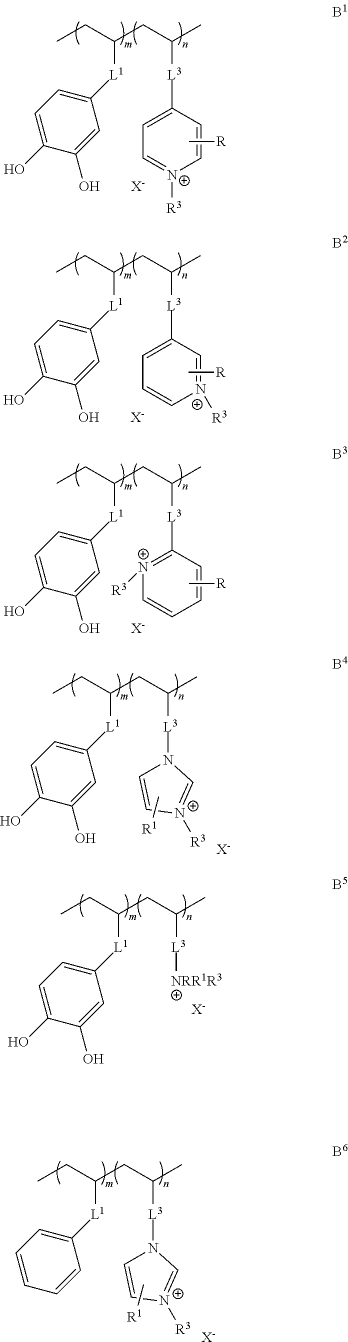
wherein:
each m and n is independently 100 to 10,000,000;
each L¹ and L³ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;
each R and R¹ is independently H or is selected from the group consisting of F, Cl, Br, I, —OH, —SiH₂OH, —NO₂, —CO₂H, —O—SO₃H, —SO₃H, —O—PO₃H₂—PO₃H₂, —NH₃⁺, —CH₃, —CH₂C₆H₅, -3,4-dihydroxyphenyl, —CH₂-3,4-dihydroxyphenyl, —NR′R″ where R′ and R″ are each independently selected from H, —CH₃, —CH₂CH₃ and —CH₂C₆H₅ or substituted benzyl or mono-, di-, tri-hydroxyl benzyl;
each R³ is independently H or is selected from the group consisting of —CO₂H, —SO₄H, —SO₃H, —PO₄H, —NH₃⁺, —CH₃, —CH₂CH₃, —CH₂C₆H₅ or substituted benzyl or mono-, di-, tri-hydroxyl benzyl; and
each X⁻ is independently a counter anion selected from the group consisting of Cl⁻, Br⁻, I⁻, —SO₄⁻² and —PO₄⁻³.

10. The method of claim 5, wherein the adhesive comprises the formulae selected from the group consisting of C¹, C², C³, C⁴, C⁵ and C⁶: 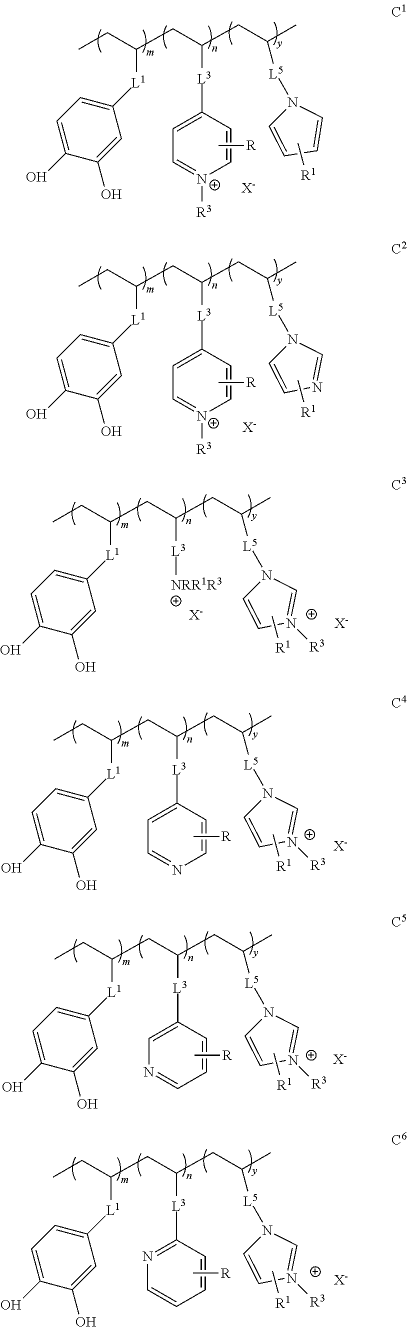
wherein:
each m, n and y is independently 100 to 10,000,000;
each L¹, L³ and L⁵ is independently selected from a bond, —CH₂—, —O—, —S—, —C(O)O—, —C(O)OCH₂—, —CH₂C(O)O—, —CH₂C(O)NH—, —C(O)NHCH₂—, —C(O)NH— and —NR′— where R′ is selected from H, —CH₃, —CH₂CH₃ and —CH₂C₆H₅ or substituted benzyl or mono-, di-, tri-hydroxyl benzyl;
each R and R¹ is independently H or is selected from the group consisting of F, Cl, Br, I, —OH, —SiH₂OH, —NO₂, —CO₂H, —SO₄H, —SO₃H, —PO₄H, —NH₃⁺, —CH₃, —CH₂C₆H₅, -3,4-dihydroxyphenyl, —CH₂-3,4-dihydroxyphenyl, —NR′R″ where R′ and R″ are each independently selected from H, —CH₃, —CH₂CH₃ and —CH₂C₆H₅ or substituted benzyl or mono-, di-, tri-hydroxyl benzyl;
each R³ is independently H or is selected from the group consisting of —CO₂H, —SO₄H, —SO₃H, —PO₄H, —NH₃⁺, —CH₃, —CH₂CH₃, —CH₂C₆H₅; and
each X⁻ is independently a counter anion selected from the group consisting of Cl⁻, Br⁻, I⁻, —SO₄⁻² and —PO₄⁻³.

11. The method of claim 1, wherein B, N and Y are each independently an aryl or a substituted aryl group.

12. The method of claim 2, wherein each R, R¹, R² and R³ is independently hydrogen or a substituted aryl group.

13. The method of claim 1, wherein at least one of A, B, M, N, X and Y is independently selected from the group consisting of the formulae:
-L¹-COOH, -L¹-O—SO₃H, -L¹-SO₃H, -L¹-O—PO₃H₂, —PO₃H₂ and -L¹-NH₃⁺;
-L³-COOH, -L³-O—SO₃H, -L³-SO₃H, -L³-O—PO₃H₂, —PO₃H₂ and -L³-NH₃⁺; and
-L⁵-COOH, -L⁵-O—SO₃H, -L⁵-SO₃H, -L⁵-O—PO₃H₂, —PO₃H₂ and -L⁵-NH₃⁺;
wherein each L¹, L³ and L⁵ is independently selected from a bond, —CH₂—, —O—, —S— and —NR′— where R′ is selected from H, —CH₃, —CH₂CH₃ and —CH₂C₆H₅.

14. The method of claim 1, wherein each of B, N and Y independently comprises a derivative of the formulae:

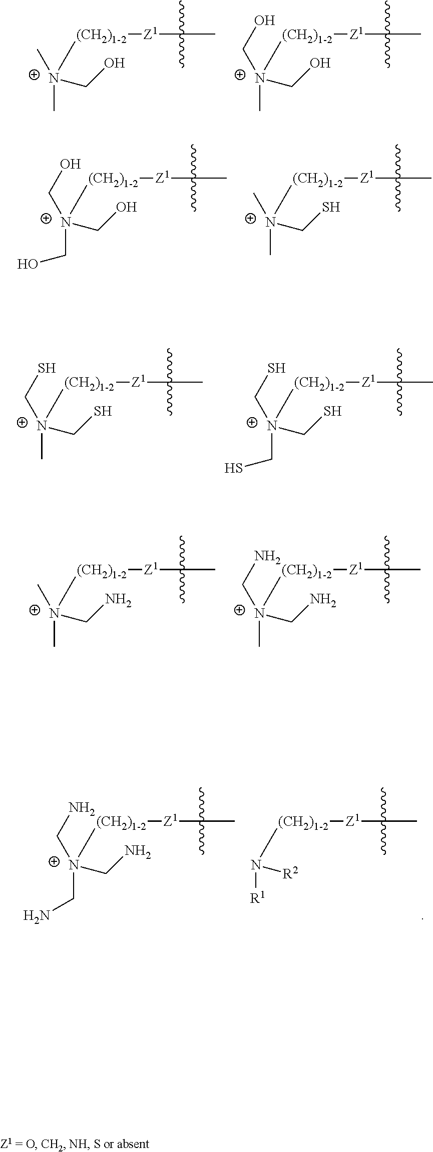

15. The method of claim 2, wherein each of B, N and Y is independently selected from the group consisting of the formulae:

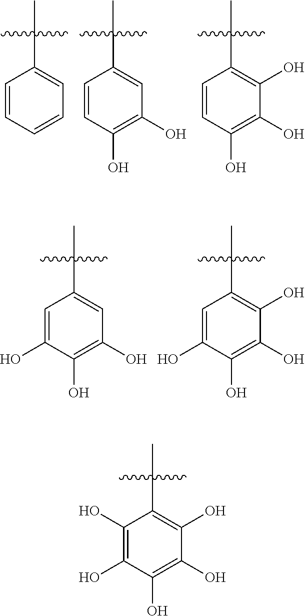

16. The method of claim 1, wherein at least one of A, M and X is independently selected from the group consisting of the formulae:

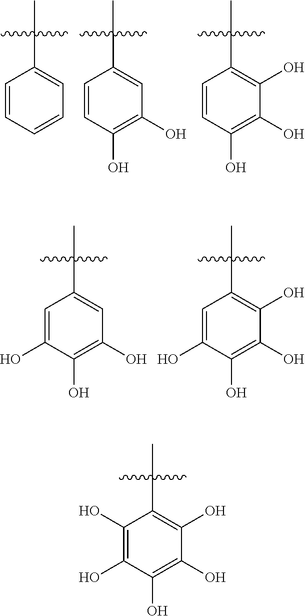

17. The method of claim 1, wherein the adhesive is enhanced in moisture, in water or in salted water.

18. The method of claim 1, wherein the surface is selected from the group consisting of human skin, wood, paper, leather, metal, plastic, foam, glass, plaster and fabric.

19. The method of claim 1, wherein the grip or tackiness of the surface is maintained even with slippery or sweaty skin.

20. The method of claim 1, wherein the solvent is selected from the group consisting of methanol, ethanol, propanol, isopropanol, acetone, THF, MEK, MIBK, MTBE, water, salted water, or mixtures thereof.
